(19) United States
(12) Patent Application Publication
(10) Pub. No.: US 2005/0144134 A1
(43) Pub. Date: Jun. 30, 2005

(54) Data handling method

(75) Inventor: Hideyuki Hirano, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/841,448

(22) Filed: May 10, 2004

(30) Foreign Application Priority Data
Dec. 26, 2003 (JP) 2003-434691

(51) Int. Cl. G06F 17/60; G06K 15/00; G06F 7/04; G08B 29/00; H04L 9/00; H04L 9/32

(52) U.S. Cl. 705/51; 358/1.14; 705/55; 705/57; 358/3.28; 705/59; 340/5.8

(57) ABSTRACT

A data handling method is presented, which prevents unauthorized use of digital content, and in particular, prevents unauthorized secondary use of cache files stored in PCs of users who have downloaded digital content from a web server, and prevents secondary use by dead-copying of image data that is presented on a display. The data handling method includes a step of associating display content of data to be distributed with user environment information, and generating data generation information related to a method for reproducing data based on the display content; a step of processing the data to be distributed based on the data generation information, storing the data generation information in the data to be distributed, and layering and distributing the data; a step of obtaining the user environment information and looking up the data generation information included in the distributed data to select a data reproduction method; and a step of reproducing the distributed data.

### FIELD OF THE INVENTION

The present invention relates to data handling methods for distributing digital content, including video images, that can be utilized subject to predetermined conditions, while striving for protection of the rights to the digital content to prevent unauthorized use.

### BACKGROUND OF THE INVENTION

For electronic publications and software, such as computer programs, electronic data is stored on magneto-optical disks (MO), digital video disks (DVD), flexible disks (FD), mini-disks (MD) or other recording media, and then sold. Ordinarily, it is easy to make copies of such electronic data, and illegal copies are rampant. Therefore, the copyrights of software vendors and publishers are infringed, and there is the risk that their profits are severely diluted.

Also for electronic data including data of still pictures and video data that are distributed via the Internet, CATV or other networks, illegal copies are rampant, thus dampening the profits of the copyright holders.

One way to protect the digital content of electronic data stored on recording media and electronic data distributed via networks is to distribute the digital content after encrypting it with an encryption key.

For example, let us consider the case that a user accesses the site of a content provider from his or her personal computer (“PC” in the following), downloads digital content to a hard-disk, and then uses that content. First, the user obtains a plug-in module for accessing the host computer and downloading the data. After that, an ID number of the used hard-disk, a CPU ID number of the used computer or other unique ID information are sent to the host computer.

The content distributor then sends the user the actual data, which is digital content encrypted with a content key, and licensing information of the content key encrypted with the user-specific ID information.

The user stores the received encrypted content data and the licensing information in encrypted form on the hard-disk. To use the digital content, the licensing information is decrypted using the user-specific ID information, such as the ID number of the hard-disk drive, thus obtaining the content key. Using this content key, the encrypted digital content can be decrypted and used.

In this case, when giving the right to use the digital content to individual users, the same encryption key for encrypting the digital content can be shared for multiple users, and by encrypting the decryption key using user-specific information that is different for each user, it is possible to grant usage rights individually.

If data is distributed with this method, the distributor of the data needs to send out the encrypted digital content and the licensing information serving as the decryption key of the encrypted digital content separately.

Moreover, the user needs to store the received encrypted digital content and the licensing information therefore separately on the recording medium.

Consequently, if the licensing information has been destroyed while being sent from the data distributor to the user, or if the licensing information on the user's recording medium has for some reason been destroyed or lost, then it is not possible anymore to use the digital content, and the procedure for obtaining the licensing information needs to be carried out again.

In order to solve this problem, a data handling method as disclosed in JP 2000-339227A has been proposed. In the data handling method described in JP 2000-339227A, the licensing information including the encryption key with which the digital content was encrypted is embedded as invisible information in sampled data extracted from the digital content, and then the encrypted digital content portion and the sample data portion are combined and distributed.

In this conventional technology, sample images for publication and original images with high product value are managed and handled as single files. For this handling, after user authentication, only authenticated users can use the original image, and users whose authentication has failed can use only on the sample image.

In this case, the digital content to be displayed on the user's PC is downloaded to the user's PC and stored as a cache file. Using such cache files, unauthorized secondary use becomes possible, and there is the possibility that original images of the restored digital content remain as cache files on the PC of authenticated users in particular, so that there is the risk of unauthorized use. Moreover, images presented on the display can be output to the printer or as image data by entering a copy command such as “Print Screen” with the keyboard, so that there is the risk of unauthorized secondary use of digital content that has been restored from the PCs of users that have been authenticated

### SUMMARY OF THE INVENTION

It is an object of the present invention to prevent unauthorized use of digital content, in particular, to prevent unauthorized secondary use of cache files stored in PCs of users who have downloaded digital content from a web server, and to prevent secondary use by dead-copying of image data that is presented on a display.

A data handling method according to the present invention comprises a step of associating display content of data to be distributed with user environment information including user license information, user authentication result information and user operation information, and generating data generation information related to a method for reproducing data based on the display content; a step of processing the data to be distributed based on the data generation information, storing the data generation information in the data to be distributed, and layering and distributing the data; a step of obtaining the user environment information of a user attempting to utilize the data, and looking up the data generation information included in the distributed data to select a data reproduction method that corresponds to the user environment information; and a step of reproducing the distributed data based on the selected data reproduction method.

It is preferable that the data to be distributed includes at least two sets of data based on the data reproduction method, and the corresponding set of data is reproduced with the data reproduction method selected in accordance with the obtained user environment information.

It is preferable that the data to be distributed is partitioned into a plurality of data portions, and some or all of the data portions are synthesized and reproduced by the data reproduction method selected in accordance with the obtained user environment information.

Moreover, it is preferable that at least two sets of data are partitioned into a plurality of data portions, and the data portions are layered and distributed.

It is preferable that operation information of an information processing device of the user is monitored by an application that is activated when the distributed data has been downloaded onto the information processing device, and the data reproduction method is selected based on the operation information obtained by the application.

It is further preferable that an authentication is performed based on user authentication information entered into an information processing device of the user, and the data reproduction method is selected based on the result of this authentication.

It is further preferable that the distributed data is data of a plurality of images, and stored in a watermark or a redundant area of a file format structure.

It is also preferable that the data of at least one of the plurality images is encrypted by an encryption key, and the encryption key is stored in the distributed data as a portion of the data generation information.

An apparatus for generation of distribution data in accordance with the present invention comprises a rule generating means for associating display content of data to be distributed with user environment information including user license information, user authentication result information, user operation information, and generating data generation information related to a method for reproducing data based on the display content; and a data generating means for processing the data to be distributed based on the data generation information, storing the data generation information in the data to be distributed, and layering the data.

It is preferable that this apparatus for generation of distribution data further comprises a user environment information managing means for managing user environment information of users to which data is distributed.

It is also preferable that the data generating means includes a data partitioning means for partitioning the data to be distributed into a plurality of data portions, and a data layering means for layering the partial data that has been partitioned by the data partitioning means.

An apparatus for reproduction of distribution data in accordance with the present invention comprises a user environment information obtaining means for obtaining user environment information of a user attempting to utilize data; a rule analyzing means for looking up data generation information included in the distributed data to select a data reproduction method corresponding to the user environment information; and a data reproducing means for reproducing the distributed data with the data reproduction method selected by the rule analyzing means.

It is preferable that the data reproduction means includes a data synthesizing means for synthesizing and reproducing the data portions included in the distributed data, based on the data reproduction method selected by the rule analyzing means.

A data handling system in accordance with the present invention comprises a rule generating means for associating display content of data to be distributed with user environment information including user license information, user authentication result information and user operation information, and generating data generation information related to a method for reproducing data based on the display content; and a data generating means for processing the data to be distributed based on the data generation information, storing the data generation information in the data to be distributed, and layering the data; a user environment information obtaining means for obtaining user environment information of a user attempting to utilize data; a rule analyzing means for looking up data generation information included in the distributed data to select a data reproduction method corresponding to the user environment information; and a data reproducing means for reproducing the distributed data with the data reproduction method selected by the rule analyzing means.

In accordance with the present invention, a program letting a computer function as an apparatus for generation of distribution data comprises a rule generating means for associating display content of data to be distributed with user environment information including user license information, user authentication result information and user operation information, and generating data generation information related to a method for reproducing data based on the display content; and a data generating means for processing the data to be distributed based on the data generation information, storing the data generation information in the data to be distributed, and layering the data.

In accordance with the present invention, a program letting a computer function as an apparatus for reproduction of distribution data comprises a user environment information obtaining means for obtaining user environment information of a user attempting to utilize data; a rule analyzing means for looking up data generation information included in the distributed data to select a data reproduction method corresponding to the user environment information; and a data reproducing means for reproducing the distributed data with the data reproduction method selected by the rule analyzing means.

In accordance with the present invention, a program letting a computer function as a data handling system comprises a rule generating means for associating display content of data to be distributed with user environment information including user license information, user authentication result information and user operation information, and generating data generation information related to a method for reproducing data based on the display content; a data generating means for processing the data to be distributed based on the data generation information, storing the data generation information in the data to be distributed, and layering the data; a user environment information obtaining means for obtaining user environment information of a user attempting to utilize data; a rule analyzing means for looking up data generation information included in the distributed data to select a data reproduction method corresponding to the user environment information; and a data reproducing means for reproducing the distributed data with the data reproduction method selected by the rule analyzing means.

With the present invention, data generation information is stored in the distributed data, and data is reproduced with a data reproduction method that is selected in accordance with user license information, user authentication result information and user operation information or the like. Thus, the displayed image data is changed in accordance with the usage rights of the user, the operations at the user terminal can be monitored, and illegal copy operations can be prevented.

### BRIEF DESCRIPTION OF THE DRAWINGS

FIG. 1 is a block diagram showing a Configuration Example 1 of the present invention.

FIG. 2 is a diagram illustrating an example of the display of image data.

FIG. 3 is a block diagram showing a Configuration Example 2 of the present invention.

FIG. 4 is a diagram illustrating a system configuration 1.

FIG. 5 is a diagram illustrating a system configuration 2.

FIG. 6 is a diagram illustrating a system configuration 3.

FIG. 7 is a flowchart showing the process flow on the server side.

FIG. 8 is a flowchart showing the process flow on the client terminal side.

FIG. 9 is a diagram illustrating a system configuration 4.

FIG. 10 is a flowchart showing the process flow on the server side.

FIG. 11 is a flowchart showing the process flow on the client terminal side.

FIG. 12 is a diagram showing the file configuration of image data portions.

FIG. 13 is a diagram illustrating a display example.

FIG. 14 is a diagram illustrating a display example.

FIG. 15 is a diagram illustrating an example of an image synthesizing rule.

FIG. 16 is a diagram illustrating an example of an image synthesizing rule.

FIG. 17 is a functional block diagram of an embodiment of the present invention.

FIG. 18 is a diagram of image display process 1.

FIG. 19 is a flowchart of image display process 1.

FIG. 20 is a diagram showing an example of a table for an image synthesizing rule.

FIG. 21 is a diagram of image display process 2.

FIG. 22 is a flowchart of image display process 2.

FIG. 23 is a diagram showing an example of a table for an image synthesizing rule.

FIG. 24 is a diagram of image display process 3.

FIG. 25 is a flowchart of image display process 3.

FIG. 26 is a diagram showing a file configuration.

FIG. 27 is a diagram showing an example of a table for an image synthesizing rule.

FIG. 28 is a diagram of image display process 4.

FIG. 29 is a flowchart of image display process 4.

FIG. 30 is a diagram showing a file configuration.

FIG. 31 is a diagram showing an example of a table for an image synthesizing rule.

FIG. 32 is a diagram of image display process 5.

FIG. 33 is a flowchart of image display process 5.

FIG. 34 is a diagram showing a file configuration.

FIG. 35 is a diagram showing an example of a table for an image synthesizing rule.

FIG. 36 is a diagram of image display process 6.

FIG. 37 is a flowchart of image display process 6.

FIG. 38 is a diagram showing an example of a table for an image synthesizing rule.

FIG. 39 is a diagram of a protected image generation process.

FIG. 40 is a diagram of a process for display switching in accordance with a condition evaluation.

### DESCRIPTION OF THE PREFERRED EMBODIMENTS

Overall Configuration

### CONFIGURATION EXAMPLE 1

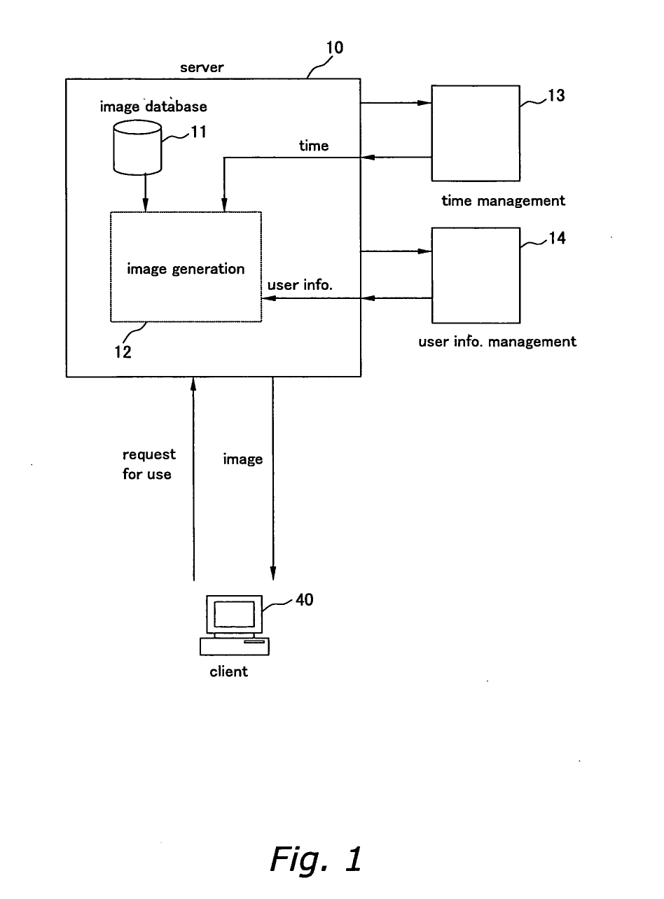

The overall configuration of an embodiment of the present invention is explained with reference to FIG. 1.

FIG. 1 shows an overview of a server distributing image data over a network, such as the Internet.

The server 10 includes an image database 11 storing image data, and an image generation portion 12 generating image data to be distributed, based on the image data stored in the image database. In accordance with the time, which is managed by a time managing means 13, the image generation portion 12 of the server 10 sets an expiration date for the image data to be distributed, and in accordance with on user information managed by a user managing means 14, it sets the usage restrictions of the image data to be distributed.

When there is a usage request for image data from a client 40, the server 10 embeds image generation information, such as usage restrictions based on expiration date and user information, into the image data with an invisible watermark, or stores the image generation information in a region that cannot be rewritten by the user, and distributes the image data.

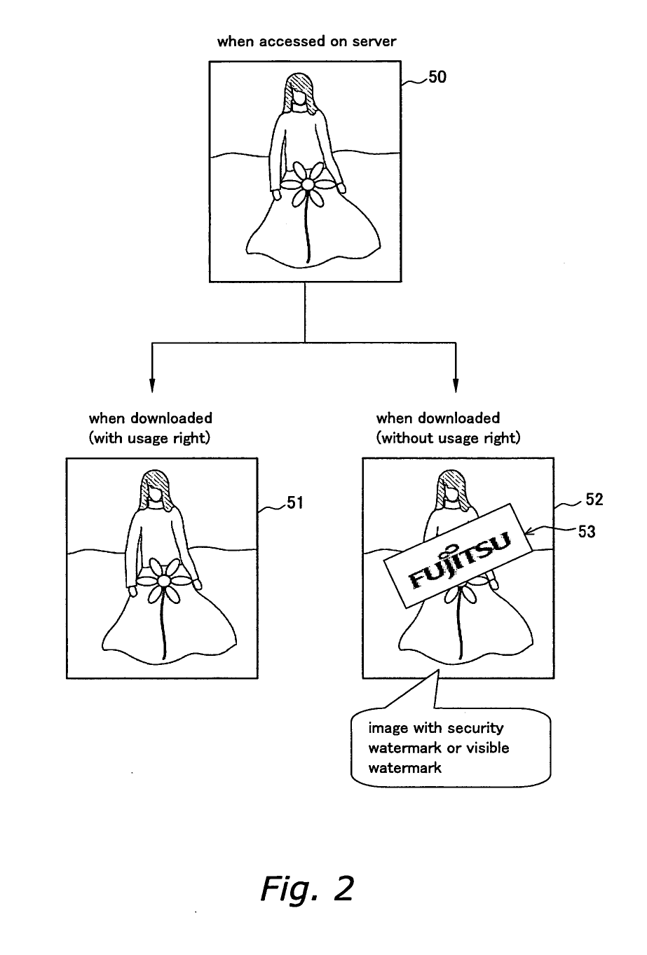

As shown in FIG. 2, image data 50 of when the server is accessible can be downloaded to the client 40 and, if the user has usage rights, displayed as an image 51 for authorized users that is the same as the original image data 50. Moreover, if the client 40 has no usage rights, then the image data is displayed with a visible watermark 53, including copyright information for example, as an image 52 for unauthorized users. Also possible is a configuration in which information about the time of access by the user, information about the terminal used by the user or other user information is embedded as an invisible watermark in the image data.

### CONFIGURATION EXAMPLE 2

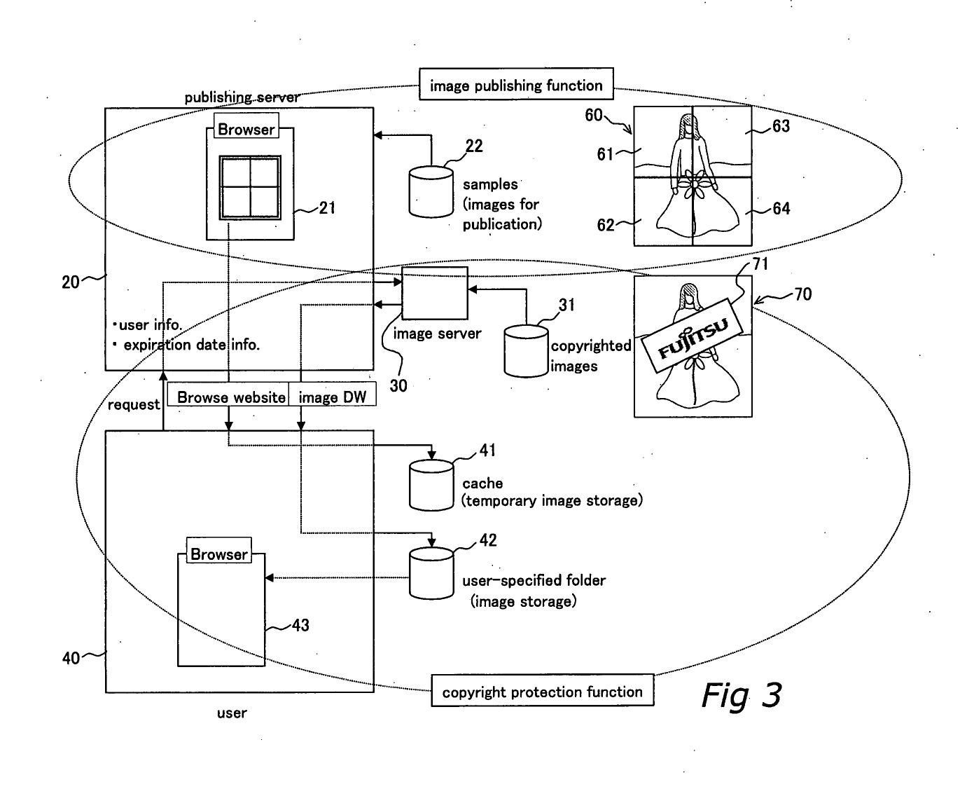

Also possible is a configuration as shown in FIG. 3.

FIG. 3 shows a configuration including a publishing server 20 publishing sample images and an image server 30 distributing image data subject to copyright protection.

The image server 30 is linked to an image database 31 storing image data subject to copyright protection, and is capable of selecting and distributing image data that is sent out from this image database 31.

The publishing server 20 is linked to a sample database 22 in which images to be published are stored, selects sample images to be published to the client terminal 40 from the sample database 22, and sends out those sample images. The sample images 60 stored in the sample database 22 correspond to the image data stored in the image database 31, and are divided into a plurality of data portions, e.g. into a first file 61 to fourth file 64, such that they can be correctly displayed by arranging them next to one another in the browser 21.

When accessing the publishing server 20 from the user terminal 40 and requesting sample data, the files 61 to 64 of the sample data are stored in a cache storage portion 41 of the harddisk, and an image-viewing application constituted by a JAVA (reg. trademark) applet or other plug-in module are downloaded. The browser 43 of the user terminal 40 synthesizes the files 61 to 64 downloaded to the code storage portion 41 and reproduces the sample data 60 by using this image-viewing application.

The image-viewing application monitors the operations of the user at the user terminal 40, and performs a reproduction restriction so that at least one data portion of the files 61 to 64 will not be properly displayed if the user enters such commands as copy (and paste), print screen or a capture command, for example.

If user information has been entered from the user terminal 40 and there is a request for image data, then user information with which the user can be specified, such as a user ID or a terminal ID, and image generation information for restricting reproduction by expiration date information or the like are generated. The image server 30 extracts the image data requested from the image database 31, stores the image generation information obtained from the publishing server 20 within the image data, and sends it to the user terminal 40 together with image data 70 for unauthorized users that is displayed if it is judged that the user has no usage rights. The image generation information may be configured such that it is embedded as an invisible watermark in the image data, and the image data 70 for unauthorized users may be image data with a visible watermark 71 embedded in the original image data. Also possible is a configuration in which the publishing server 20 receives image data from the image server 30, stores the image generation information in the distributed image data, and generates the distribution data together with the image data 70 for unauthorized users.

The image data distributed via the publishing server 20 is stored in a user-specified folder 42 on the harddisk of the user terminal 40 or on a floppy disk, CD-R, CD-RW or other recording medium. An image-viewing application configured as a plug-in module for viewing image data is included in the distributed image data. This image-viewing application judges from the user ID entered by the user and the expiration data whether the user has the usage rights to the image data, and depending on whether the user has usage rights, the image-viewing application determines whether the regular image data is displayed or the data for unauthorized users is displayed. Moreover, the image-viewing application is configured to monitor the operations of the user at the user terminal 40, and to ensure that the proper image data is not displayed if the user has entered such commands as copy (and paste), print screen or a capture command.

Thus, it is possible to realize an image publication function with which sample data is published by the publishing server 20, and a copyright protection function with which the copyrights of image data managed by the image server 30 are protected.

System Configuration 1

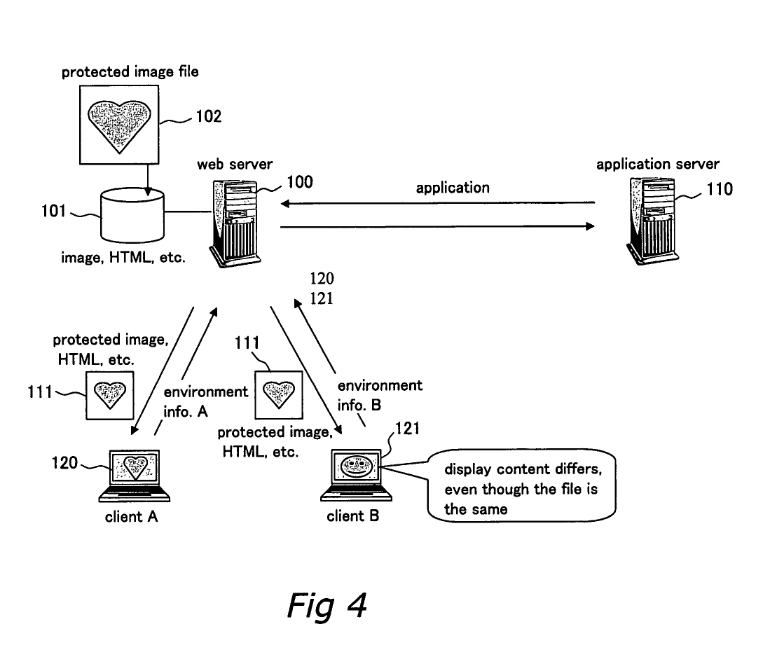

FIG. 4 shows a system configuration 1 serving as a basic configuration.

This system configuration 1 is constituted by a web server 100 for distributing image data and an application server 110 managing an image-viewing application for implementing a reproduction restriction.

The web server 100 manages an image database 101 storing image data 102 subject to copyright, and can distribute the image data, in response to distribution requests, to a plurality of client terminals accessing the web server through a network. The image data distributed by the web server 100 includes the image data 102 stored in the image database 101, the image generation information relating to the data reproduction method in accordance with the user's environment information, the image data for unauthorized users, and the image-viewing application for implementing a reproduction restriction.

If, for example, a user having usage rights requests image data 102 with the client terminal 120 from the web server 100, then the user ID of the user using the client terminal 120, the terminal ID of the client terminal and other user environment information A is sent to the web server 100, and distribution data 111 including the image data 102 and the image generation information is sent to the client terminal 120.

Similarly, if a user not having usage rights requests image data 102 with the client terminal 121 from the web server 100, then the user ID of the user using the client terminal 121, the terminal ID of the client terminal and other user environment information B is sent to the web server 100, and distribution data 111 including the image data 102 and the image generation information is sent to the client terminal 120.

In this case, the distribution data 111 sent to the client terminals 120 and 121 is identical, but the image-viewing application included in the distribution data 111 selects the reproduction method in accordance with the user environment information, and the image data subject to copyright protection is reproduced on the client terminal 120, whereas the image data for unauthorized users is reproduced on the client terminal 121 of the user without usage rights. If the user's expiration date for the image data 102 has passed on the client terminal 120, then that user is regarded as not having usage rights, and the image data for unauthorized users will be displayed.

Moreover, the image-viewing application monitors the operations of the user at the user terminal, and restricts reproduction by ensuring that the image data 102 is not displayed properly if the user enters such commands as copy (and paste), print screen or a capture command.

Thus, in this system configuration 1, a hardware ID or hardware configuration (PC hardware environment) of the client terminal, information entered by the user with a keyboard (PC software environment), the user's voiceprint, fingerprints or other biometric information or a password (user authentication information) or image license information can be used as the user environment information.

System Configuration 2

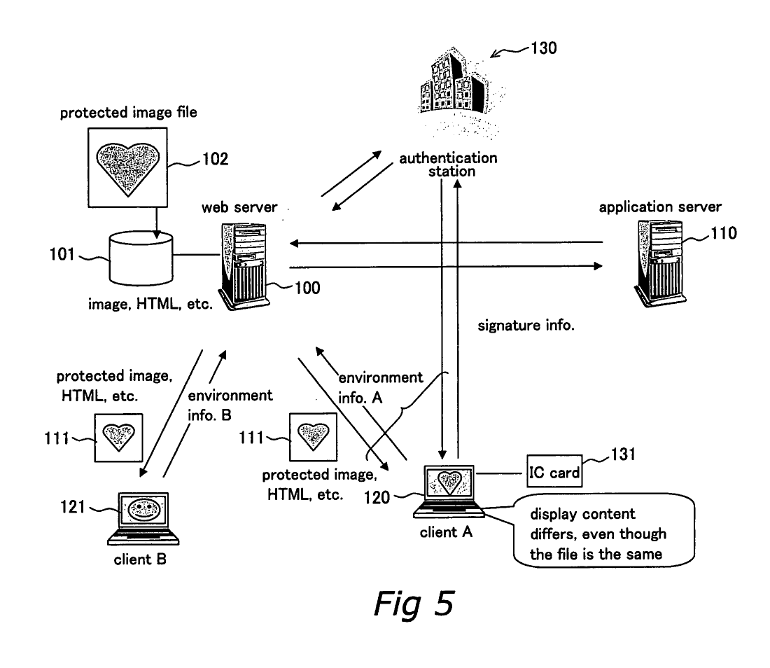

A system configuration 2 for the case that the user environment information is evaluated by a third-party organization is explained with reference to FIG. 5.

This system configuration 2 is constituted by a web server 100 for distributing image data and an application server 110 managing an image-viewing application for implementing a reproduction restriction, like the above-described basic configuration.

The web server 100 manages an image database 101 storing image data 102 subject to copyright, and can distribute the image data, in response to distribution requests, to a plurality of client terminals accessing the web server through a network. The image data distributed by the web server 100 includes the image data 102 stored in the image database 101, the image generation information relating to the data reproduction method in accordance with the user's environment information, the image data for unauthorized users, and the image-viewing application for implementing a reproduction restriction.

The web server 100 is linked to an authentication station 130 for authentication of users. If there is a request for image data from a user, then the web server 100 requests signature information from the authentication station 130, and performs an authentication by comparing this signature information with the user information that is sent from the client terminal of the user. The web server 100 generates the image generation information in accordance with the result of this authentication, stores it in the image data, and sends the distribution data to the client terminal.

Let us consider, for example, the case that the user of the client terminal 120 registers signature information with the authentication station 130, and the registered signature information is stored on an IC card. When the user requests the image data from the client terminal 120, the signature information stored in the IC card 131 is sent as user environment information A to the web server 100. Based on the received user environment information A, the web server 100 requests the user's signature information from the authentication office 130, and authenticates the user. As a result, if the authentication is successful, the web server 100 generates image generation information indicating that the use of the image data is allowed, stores it the image data 102 and sends it as the distribution data 111 to the client terminal 120.

Similarly, if a user without usage rights requests the image data 102 with the client terminal 121 from the web server 100, then the user ID of the user using the client terminal 121, the terminal ID of the client terminal and other user environment information B are sent to the web server 100. If no signature information is included in the user environment information B, then the web server 100 generates image generation information indicating that the user is not an authorized user, stores this image generation information in the image data 102, and sends it together with the image data for unauthorized users as distribution data 111 to the client terminal 121. Also when the user environment information B includes signature information, but the authentication by comparison with the signature information sent from the authentication station 130 has failed, then the web server 100 generates image generation information indicating that the user is not an authorized user, stores this image generation information in the image data 102, and sends it as distribution data 111 to the client terminal 121. As a result, the image data for unauthorized users is reproduced by the client terminal 121.

System Configuration 3

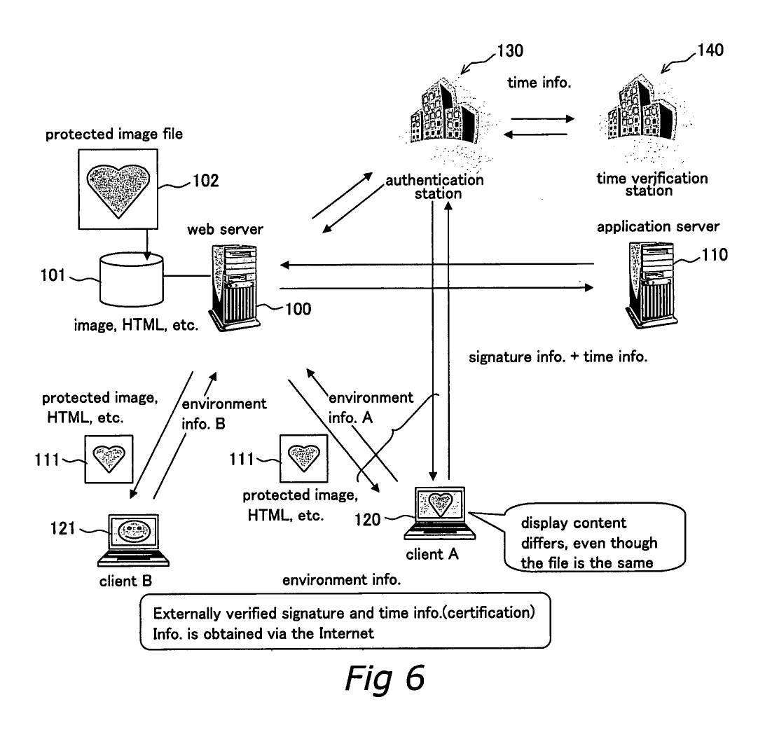

A system configuration 3 for the case that the user environment information is evaluated by a third-party organization, and signature information and time information are authenticated is explained with reference to FIG. 6.

This system configuration 3 is constituted by a web server 100 for distributing image data and an application server 110 managing an image-viewing application for implementing a reproduction restriction, like the above-described basic configuration.

The web server 100 manages an image database 101 storing image data 102 subject to copyright, and can distribute the image data, in response to distribution requests, to a plurality of client terminals accessing the web server through a network. The image data distributed by the web server 100 includes the image data 102 stored in the image database 101, the image generation information relating to the data reproduction method in accordance with the user's environment information, the image data for unauthorized users, and the image-viewing application for implementing a reproduction restriction.

The web server 100 is linked to an authentication station 130 for authentication of users and to a time verification station 140 for verification of time information. If there is a request for image data from a user, then the web server 100 requests signature information from the authentication station 130, and requests verification of time information from the time verification station 140. The web server 100 moreover performs an authentication by comparing the signature information sent from the authentication station 130 and the time information sent from the time verification station 140 with the user information that is sent from the client terminal of the user. The web server 100 generates the image generation information in accordance with the result of this authentication, stores it in the image data, and sends the distribution data to the client terminal.

Let us consider, for example, the case that the user of the client terminal 120 registers signature information with the authentication station 130. When the user requests the image data from the client terminal 120, the signature information stored in an IC card or the like and time information are sent as user environment information A to the web server 100. Based on the received user environment information A, the web server 100 requests the user's signature information from the authentication office 130, requests time information from the time verification station 140, authenticates the user, and verifies the time information. As a result, if the authentication is successful, the web server 100 generates image generation information indicating that the use of the image data is allowed, stores it the image data 102 and sends it as the distribution data 111 to the client terminal 120.

Similarly, if a user without usage rights requests the image data 102 with the client terminal 121 from the web server 100, then the user ID of the user using the client terminal 121, the terminal ID of the client terminal and other user environment information B are sent to the web server 100. If no signature information is included in the user environment information B, then the web server 100 generates image generation information indicating that the user is not an authorized user, stores this image generation information in the image data 102, and sends it together with the image data for unauthorized users as distribution data 111 to the client terminal 121. Also when the user environment information B includes signature information and time information, but the authentication by comparison with the signature information sent from the authentication station 130 and with the time information sent from the time verification station 140 has failed, then the web server 100 generates image generation information indicating that the user is not an authorized user, stores this image generation information in the image data 102, and sends it as distribution data 111 to the client terminal 121. As a result, the image data for unauthorized users is reproduced by the client terminal 121.

Process Flow of System Configurations 1 to 3

The process flow in the above-described system configurations 1 to 3 is outlined with reference to the drawings.

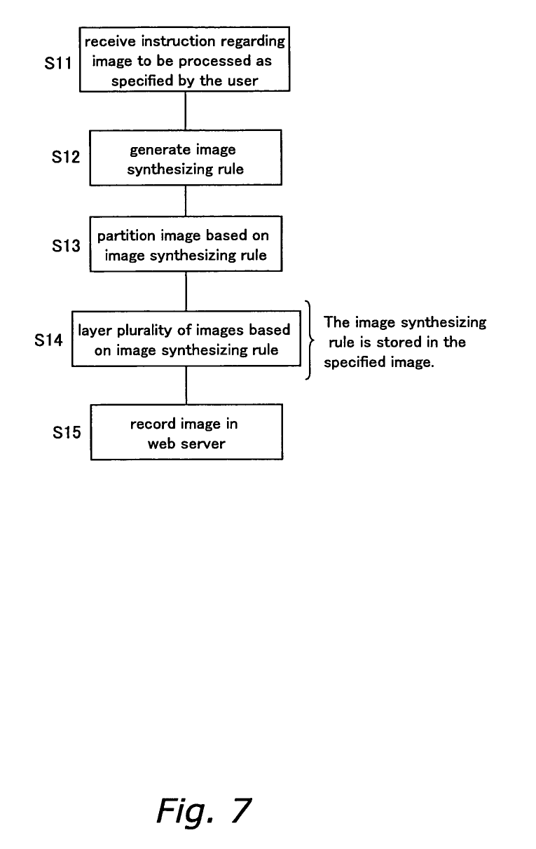

FIG. 7 is a flowchart of the process flow of the web server on the image management side.

At Step S11, an instruction regarding an image to be processed as specified by the user is received. Here, if the user accesses the web server using a client terminal, a page for data selection is sent to the client terminal, and the instruction regarding image data to be processed is received from the user. In this situation, the web server requests and receives a user ID, fingerprints or a voiceprint of the user, or other biometric information, a password, a terminal ID of the client terminal or other user environment information.

At Step S12, image generation information, such as an image synthesizing rule, is generated for the image data specified by the user, in response to the obtained user environment information. An image synthesizing rule is, for example, a rule that ensures that the image data is distributed partitioned in a plurality of data portions, that the individual data portions are properly synthesized into image data to be displayed for users having the proper usage rights, and that one or all of the data portions cannot be displayed or displaying other image data instead if the user has no usage rights (i.e. the authentication has failed) or if the expiration date has passed.

At Step S13, the image data is partitioned into a plurality of data portions, based on the generated image synthesizing rule. Several methods for partitioning the image data into a plurality of data portions are conceivable. For example, it is possible to partition the image data into four equal portions, as shown in FIG. 3, and the other partition methods can be set up as appropriate.

At Step S14, the plurality of images are layered in accordance with the image synthesizing rule, and distribution data is generated. For example, the distribution data may be generated by embedding copyright information as a visible watermark in the image data, and embedding image generation information including the image synthesizing rule as an invisible watermark in sample data extracted from the image data, and integrating these image data into one. It is also possible to encrypt the image data with an encryption key, to embed image generation information including this encryption key and the image synthesizing rule in the sample data extracted from the image data as an invisible watermark, and to integrate it into one with the image data for unauthorized users that is displayed to users without usage rights, thus generating the distribution data.

At Step S15, the generated distribution data is stored in the web server 100.

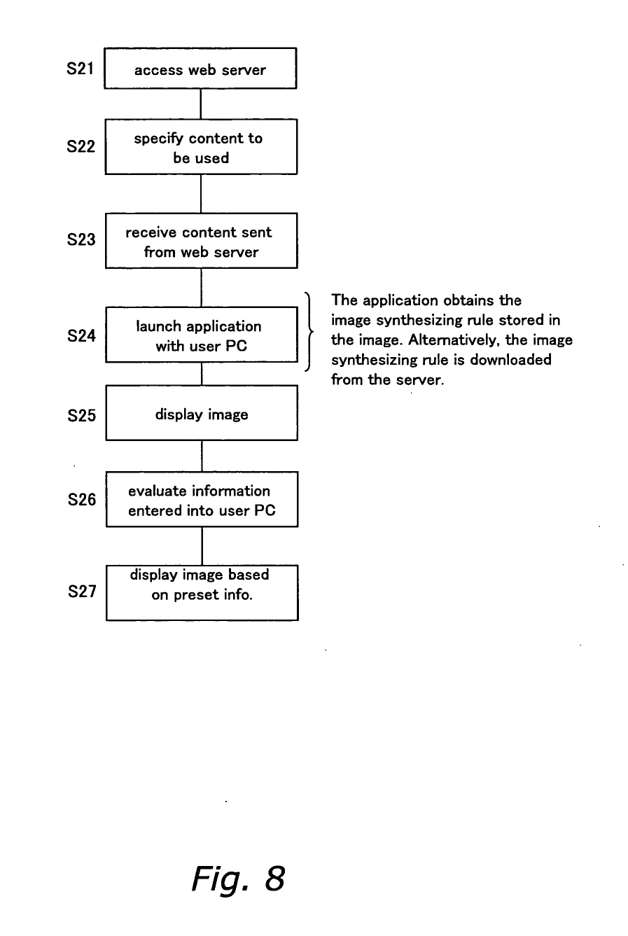

The process flow of the client terminal on the user side is explained with reference to the flowchart in FIG. 8.

At Step S21, the client terminal accesses the web server via a network, such as the Internet.

At Step S22, the client terminal accesses a page on which image data can be selected, and receives information specifying certain image data from the user. This specifying information is sent from the client terminal to the web server 100.

At Step S23, the content sent from the web server 100 is received.

At Step S24, the image-viewing application included in the data sent from the web server 100 is launched. This image-viewing application obtains the image synthesizing rule stored in the image data, or obtains an image synthesizing rule from the server by accessing a predetermined URL.

At Step S25, the image-viewing application displays the image data based on the obtained image synthesizing rule. Here, the user can be authenticated using a user ID, a password, a terminal ID of the client terminal, the user's fingerprints, palm print, iris scan, retinal scan, voiceprint, DNA or other biometrical information, or signature information issued by an authentication station, and either the image data for authorized users or the image data for unauthorized users can be displayed, depending on the authentication result.

At Step S26, it is determined whether there has been an input from the user via an input/output interface. If it is determined that there has been an input, then it is evaluated what information has been input.

At Step S27, corresponding image data is displayed, depending on the information input by the user. For example, if the user has input an image control command, such as a copy (and paste), print screen or capture command, then a display restriction is performed by controlling the image data such that it cannot be displayed properly, or by switching to image data for unauthorized users.

System Configuration 4

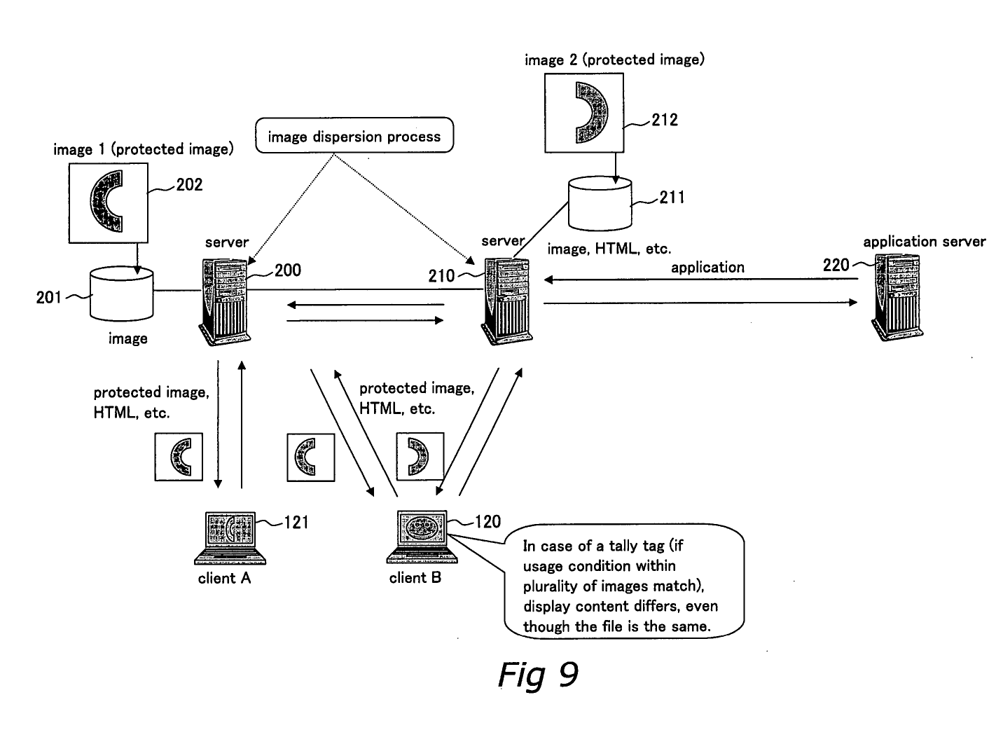

FIG. 9 illustrates a case in which the image data is managed distributed over different servers, and only the image information from one server is displayed to unauthorized users not having the proper usage rights, whereas the image data from both servers is displayed to authorized users having the proper usage rights.

The system configuration 4 is provided with a first server 200, a second server 210, and an application server 220 managing an image-viewing application. The first server 200 manages a first image 202 stored in a first image database 201. The second server 210 manages a second image 212 stored in a second image database 211. The first image data 202 stored in the first image database 201 and the second image data 212 stored in the second image database 211 belong to one set of image data that has been partitioned, and the first image data 202 stored in the first image database 201 is sent to unauthorized users not having proper usage rights, whereas the first image data 202 stored in the first image database 201 and the second image data 212 stored in the second image database 211 are sent to authorized users having the proper usage rights, so that the original image data can be used properly.

For example, when an ordinary user (unauthorized user) receives image data with a client terminal 121, the first server 200 is accessed, and the first image data 202 stored in the first image database 201 is received. In this case, the first image data 202 is sample data constituting a portion of the original image data, and when using the image data on the client terminal 121, only a portion of the original image data is displayed.

If a user who has looked at the sample image has become a properly authorized user by obtaining a license from the provider of the data, then that user may access the second server 210. For example, if an authorized user having proper usage rights has accessed the server 210 via the client terminal 120, then the user is authenticated, the first image 202 is sent via the first server 200, and the second image data 212 managed by the second server 210 is sent to the client terminal 120. In this case, the second server 210 generates a synthesizing rule of the image data, stores image generation information including the user's license information and the image synthesizing rule within the second image data 212, and sends it to the client terminal 120 after attaching the image-viewing application obtained from the application server 220. Thus, the original image data can be reproduced with the client terminal 120 by synthesizing the first image data 202 and the second image data 212 using the image generation information stored in the second image data 212.

Process Flow of the System Configuration 4

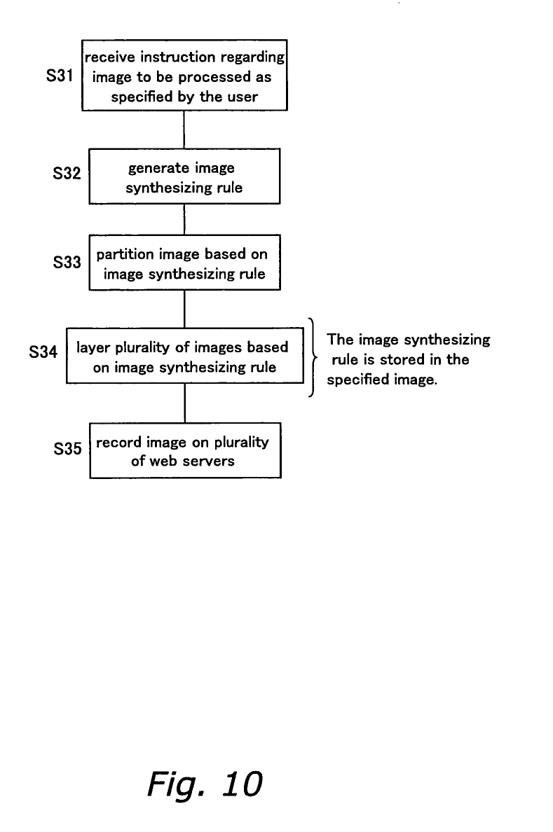

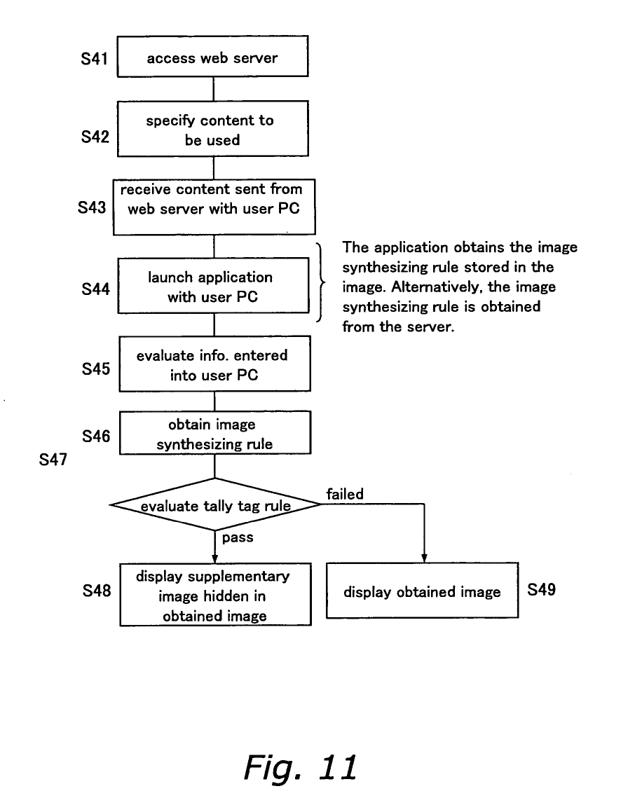

The process flow of the system configuration 4 is explained with reference to the flowchart in FIGS. 10 and 11.

FIG. 10 is a flowchart of the process flow of the server on the image manager side.

At Step S31, an instruction regarding the image to be processed as specified by the user is received. Here, if the user accesses the server using a client terminal, a page for data selection is sent to the client terminal, and an instruction regarding the image data to be processed is received from the user. In this situation, a user ID, the user's fingerprints, voiceprint or other biometric information, a password, a terminal ID of the client terminal or other user environment information is requested and received.

At Step S32, image generation information, such as the image synthesizing rule, for the image data specified by the user is generated in accordance with the obtained user environment information. The image synthesizing rule is a rule that implements a display restriction, ensuring, for example, that the image data is partitioned into a plurality of data portions before being distributed, that image data obtained by synthesizing the first image data 202 and the second image data 212 is displayed to users having the proper usage rights, and that only the first image data 202 is displayed if the user has no usage rights (i.e. the authentication has failed) or if the expiration date has passed.

At Step S33, the image data is partitioned into a plurality of data portions based on the generated image synthesizing rule. Here, it is assumed that the original image data is partitioned into first image data 202 managed by the first server 200 and second image data 212 managed by the second server 210.

At Step S34, the image data is layered in accordance with the image synthesizing rule. For example, the image generation information can be embedded as an invisible watermark within the second image data 212, which is a portion of the original image data, thus constituting layered data. Moreover, it is possible to embed a portion of the image generation information as an invisible watermark respectively in the first image data 202 and in the second image data 212, so that the image generation information can be obtained only when both the first image data 202 and the second image data 212 are present.

At Step S35, distribution data based on the generated first image data 202 and the second image data 212 is recorded in the first server 200 and the second server 210, respectively.

The process flow of the client terminal on the user side is explained with reference to the flowchart in FIG. 11.

At Step S41, the client terminal accesses the web server via a network, such as the Internet, based on a user instruction. Here, it is also possible that either the first server 200 or the second server 210 is accessed, or that both the first server 200 and the second server 210 are accessed.

At Step S42, the client terminal accesses a page with which image data can be selected, based on a user instruction, receives specifying instruction information specifying the image data from the user, and sends it to the server.

At Step S43, the client terminal receives the content sent from the server in accordance with the information specifying the image data. The client terminal can be configured such that, at this time, the first image data 202 is received from the first server 200, and the second image data 212 is received from the second server 210, or such that only the first image data is received from the first server 200.

At Step S44, the client terminal launches the image-viewing application included in the received data. This image-viewing application obtains the image synthesizing rule stored in the image data, or obtains the image synthesizing rule from the server by accessing a predetermined URL, and performs a display restriction based on the user's authentication result.

At Step S45, the client terminal obtains input information from the user and analyzes this input information. Here, the user can be authenticated by obtaining input information such as a user ID or a password entered by the user, a terminal ID of the client terminal, the user's fingerprints, palm print, iris scan, retinal scan, voiceprint, DNA or other biometrical information, or signature information issued by an authentication station, and comparing it with the user environment information included in the image data.

At Step S46, the client terminal obtains the image synthesizing rule included in the image data with the image-viewing application.

At Step S47, the client terminal performs a tally tag rule evaluation by comparing the result of the user authentication with the image synthesizing rule. Here, if it is judged from the user authentication result that the user is a properly authorized user, then the procedure advances to Step S48, and otherwise the procedure advances to Step S49.

At Step S48, the first image data 202 received from the first server 200 and the second image data 212 received from the second server 210 are synthesized and the image data is displayed to the properly authorized user.

At Step S49, only the second image data 202 received from the first server 200 is displayed.

The first image data 202 managed by the first server 200 and the second image data 212 managed by the second server 210 may be both configured to include hidden supplementary image data, and based on the result of the evaluation of the tally tag rule, the hidden supplementary image data may be synthesized and displayed in Step S48, whereas the obtained image data may be displayed as is in Step S49.

The Display Restriction Function

For the plurality of data portions into which the data of one image has been partitioned, it is possible to adopt a form allowing for a plurality of image data portions in respective file format structures, or to adopt a form in which the other image data portions are stored as an electronic watermark within one image data portion.

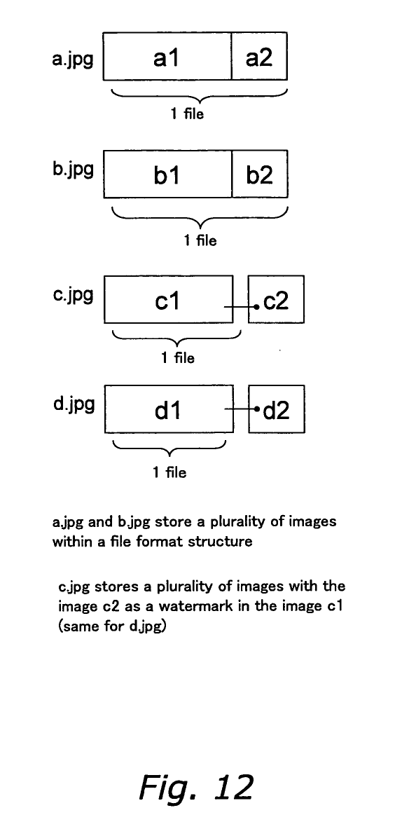

For example, in the example shown in FIG. 12, the original image data is partitioned into the four image data portions “a.jpg” to “d.jpg.” “a.jpg” is of a form in which a first image data portion al and a second image data portion a2 are stored within a single file format structure, and also “b.jpg” is of a form in which a first image data portion b1 and a second image data portion b2 are stored within a single file format structure. “c.jpg” is of a form in which a second image data portion c2 is embedded as an electronic watermark in a first image data portion c1, and also “d.jpg” is of a form in which a second image data portion d2 is embedded as an electronic watermark in a first image data portion d1.

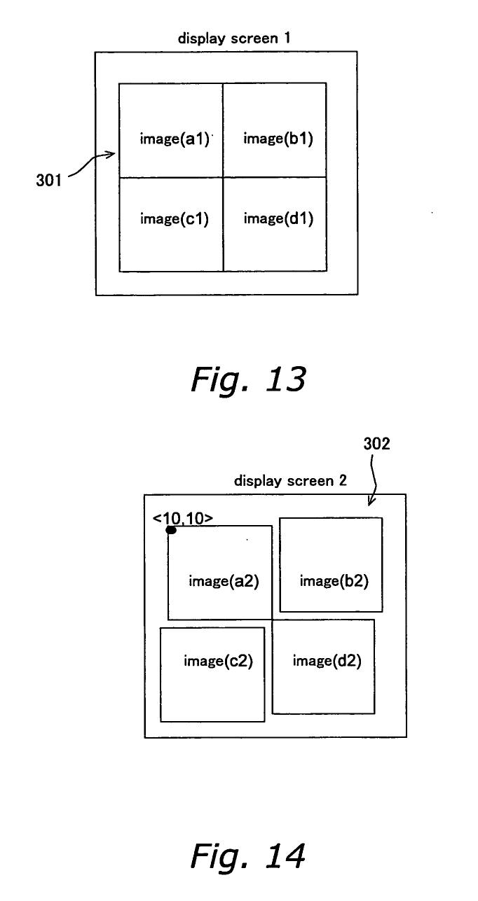

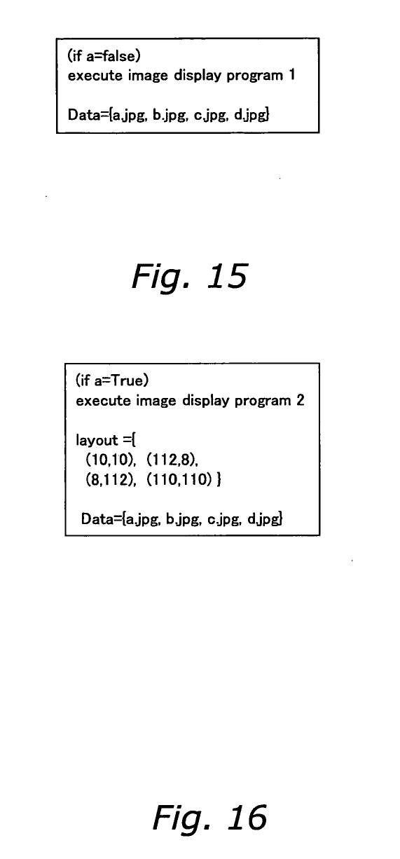

Thus, when the image data partitioned into the image data portions “a.jpg” to “d.jpg” is displayed, and the result of the evaluation of the information input by the user is “failed,” then first image data 301 obtained by synthesizing al to d1, which is the image data for unauthorized users, will be displayed, as shown in FIG. 13. Such an image synthesizing rule for performing a display restriction can be expressed by the pseudo-code given in FIG. 15. Here, if the evaluation result a is “false,” then an image display program 1 selecting the first image data a1 to d1 included in “a.jpg” to “d.jpg” is executed, and the first image data 301 in FIG. 13 is displayed by arranging the image portions based on the layout information set in each of the image data portions.

If the result of the evaluation of the information input by the user is “pass,” then the second image data 302 obtained by synthesizing a2 to d2, which is the image data for authorized users, is displayed, as shown in FIG. 14. The image synthesizing rule for performing such a display restriction can be expressed by the pseudo-code given in FIG. 16. Here, if the evaluation result a is “true,” then an image display program 2 selecting the second image data a2 to d2 included in “a.jpg” to “d.jpg” is executed, and the second image data is arranged based on the layout information set in each of the image data portions. If the second image data a2 and b2 stored in “a.jpg” and “b.jpg” is encrypted, then the image display program 2 can be configured to extract the encryption key from the image generation information and decrypt the second image data a2 and b2 using this encryption key. Moreover, the image display program 2 is configured to obtain information about the type of the electronic watermark embedded in “c.jpg” and “d.jpg” and information relating to its extraction method from the image generation information, and to restore the second image data c2 and d2. Thus, by arranging the restored second image data a2 to d2 based on the layout information, it is possible to display the second image data 302 in FIG. 14.

Functional Configuration

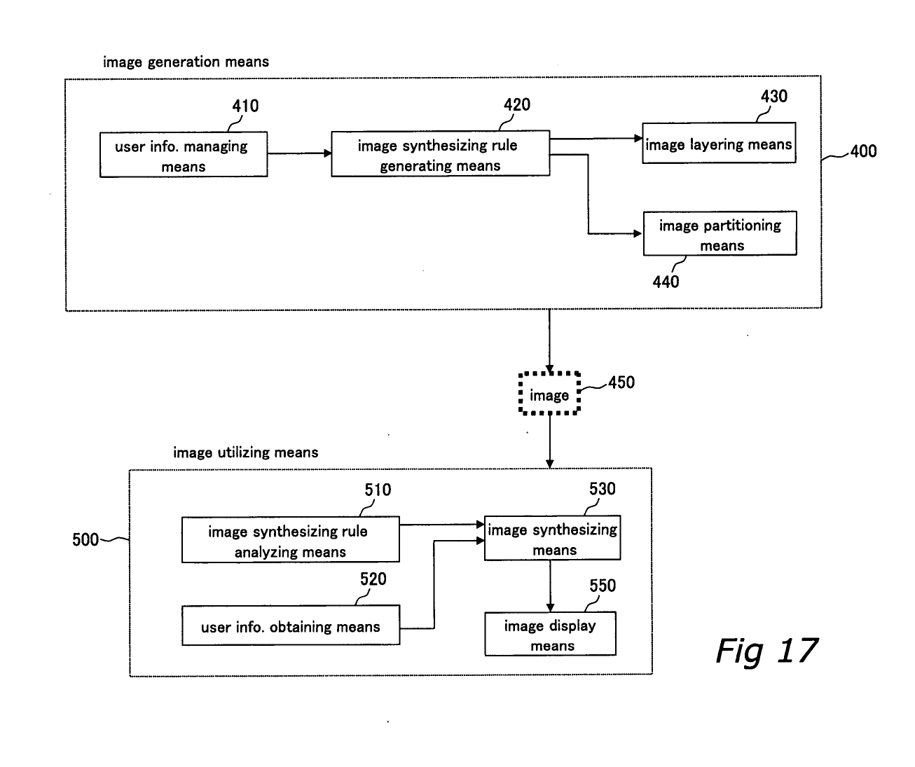

FIG. 17 is a functional block diagram of an embodiment of the present invention.

An image generation portion 400 for generating image data 450 to be distributed is provided on the server side, and this image generation portion 400 includes a user information managing means 410 for managing user information such as user IDs, passwords, user terminal IDs, biometrical information of users (such as fingerprints, palm prints, iris scans, retinal scans, voiceprint DNA or the like), and expiration date information, an image synthesizing rule generating means 420 for generating image synthesizing rules based on the user information, an image partitioning means 440 for partitioning image data into image data portions based on the image synthesizing rules, and an image layering means 430 for performing data embedding in form of storing the data of a plurality of images in one file format structure or in form of electronic watermarking.

An image utilization portion 500 for reproducing the image data 450 distributed from the server side is provided on the client terminal side, and this image utilization portion 500 includes an image synthesizing rule analyzing means 510 for extracting the image synthesizing rule included in the distributed data, a user information obtaining means 520 for obtaining user environment information such as a user ID, a password, a user terminal ID, biometrical information of the user (such as fingerprints, palm prints, iris scans, retinal scans, voiceprint DNA or the like), information representing the current time and information input by the user, an image synthesizing means 530 for evaluating a usage condition based on the image synthesizing rule included in the distributed data and the user environment information obtained by the user information obtaining means 520 and applying an image synthesizing rule based on the evaluation results, and an image display means 550 for displaying the image data generated by the image synthesizing means 530.

Image Display Process 1

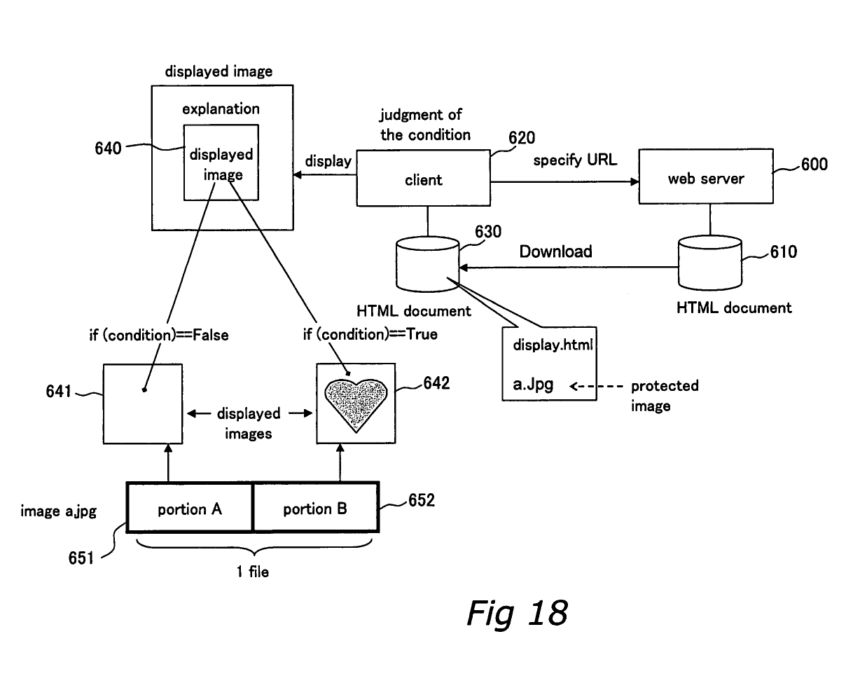

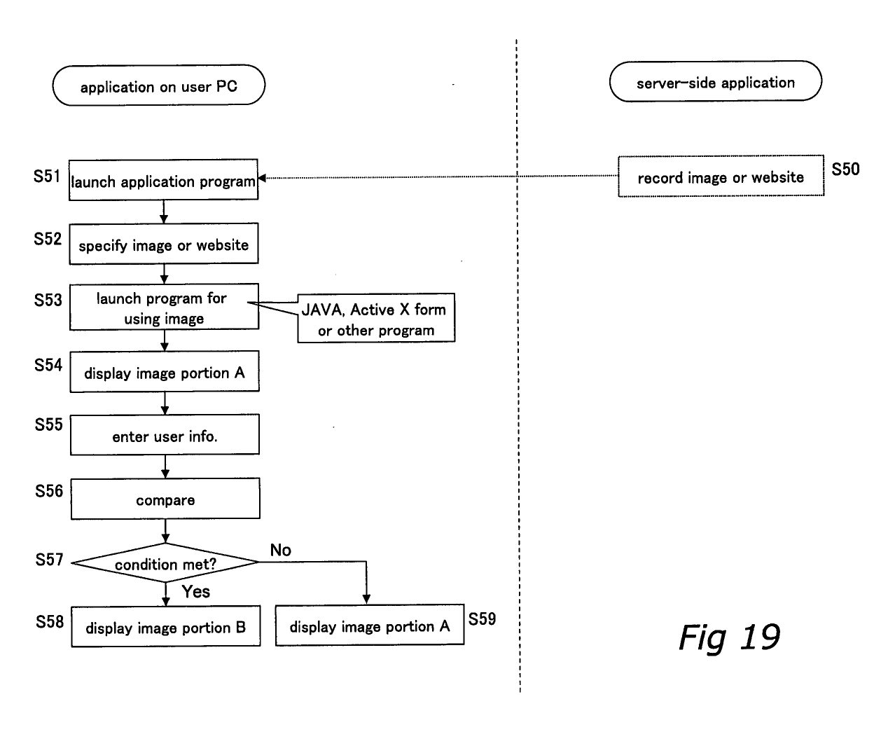

As the image display processing method, it is possible to store the data of two images in one file format, and to display either of the image data in accordance with the evaluation of the user authentication result and the expiration date, for example. Such a process is explained as image display process 1 with reference to FIGS. 18 and 19.

A web server 600 is configured to manage a data storage portion 610, which manages HTML documents including image data to be distributed, and to distribute image data in response to requests from a client terminal 620.

The client terminal 620 manages a data storage portion 630, which can store the distributed data, and stores HTML documents including image data distributed from the web server 600 in the data storage portion 630.

An application stored in the distributed data is launched by the client terminal 620, the user environment information is judged, and a display image 640 is displayed with a display means, based on the result of that judgment.

The image data “a.jpg” distributed from the web server 600 is a file including a first file 651 and a second file 652, and first image data 641 obtained by expanding the first file 651 or second image data 642 obtained by expanding the second file 652 is displayed depending on an evaluation result.

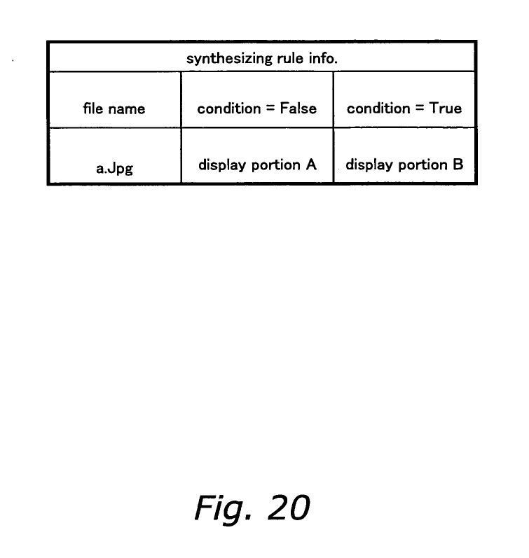

The image synthesizing rule can be expressed by a table as shown in FIG. 20. In this case, the first file 651 is selected from the file “a.jpg” if the evaluation result is “false” and the second file 652 is selected from the file “a.jpg” if the evaluation result is “true.”

FIG. 19 is a flowchart showing the process flow according to this image display process 1.

At Step S50, the application on the side of the web server 600 records the URL of image data or a web page.

At Step S51, the client terminal 620 launches an application program such as a browser for connecting to the Internet and accessing the image data or the web page recorded by the server.

At Step S52, information specifying the image data or web page specified by the user is entered into the client terminal 620 and the client terminal 620 receives the data distributed by the web server 600.

At Step S53, the client terminal 620 launches the image-viewing application included in the distributed data. This image-viewing application may be a JAVA (registered trademark) applet, an ActiveX form or other program.

At Step S54, the image-viewing application of the client terminal 620 selects the first file 651 from the image data “a.jpg” included in the distributed data, expands it and temporarily displays the first image data 641.

At Step S55, the image-viewing application of the client terminal 620 receives the user environment information entered by the user. Here, both a user ID and a password, a fingerprint or voiceprint or other biometrical information, a client terminal ID, the current time, and a command input relating to display control are received as user environment information.

At Step S56, the image-viewing application compares the user environment information entered by the user with the image generation information included in the distributed data. A user authentication is performed, for example, by comparing the user ID, the password, the user biometrical information and the client terminal ID or the like included in the user environment information entered by the user with the user environment information included in the image generation information. Moreover, based on the obtained current time information, it is determined whether the expiration date has passed or not. Furthermore, it is determined whether a command relating to display control, such as a copy (and paste), printscreen or capture command, has been entered.

At Step S57, the image-viewing application decides whether the conditions are met or not. If the user authentication has failed, if it is determined from the current time information that the expiration date has passed, or if it is determined that a command related to display control has been entered, then the procedure advances to Step S59, and otherwise the procedure advances to Step S58.

At Step S58, the image-viewing application selects the second file 652 from the image data “a.jpg” included in the distributed data, expands it, and displays the second image data 642. If, as noted before, the image data “ajpg” is configured such that two files are stored in one file format structure, then the second image data 642 can be expanded and displayed instead of the currently displayed first image data 641. If the second image data 642 is encrypted and the encryption key is embedded as an invisible watermark in the first file 651, then the image-viewing application retrieves the encryption key by obtaining the rule relating to the method for retrieving the encryption key from the image generation information, the second file 652 is decrypted using this encryption key, and the second image data 642 is expanded. Moreover, also if the second file 652 is embedded as an invisible watermark in the first file 651, the image-viewing application may be configured to obtain the rule relating to the method for retrieving the second file from the image generation information, and to generate the second image data 642 by retrieving and expanding the second file 652.

At Step S59, the image-viewing application selects the first file 651 from the image data “a.jpg” included in the distributed data, and displays the first image data 642.

Image Display Process 2

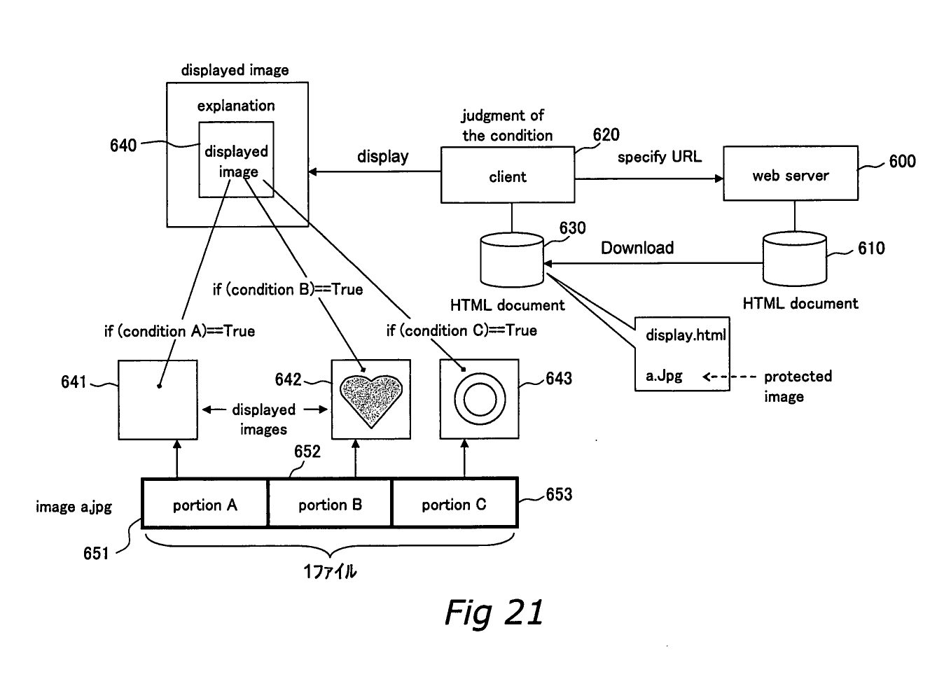

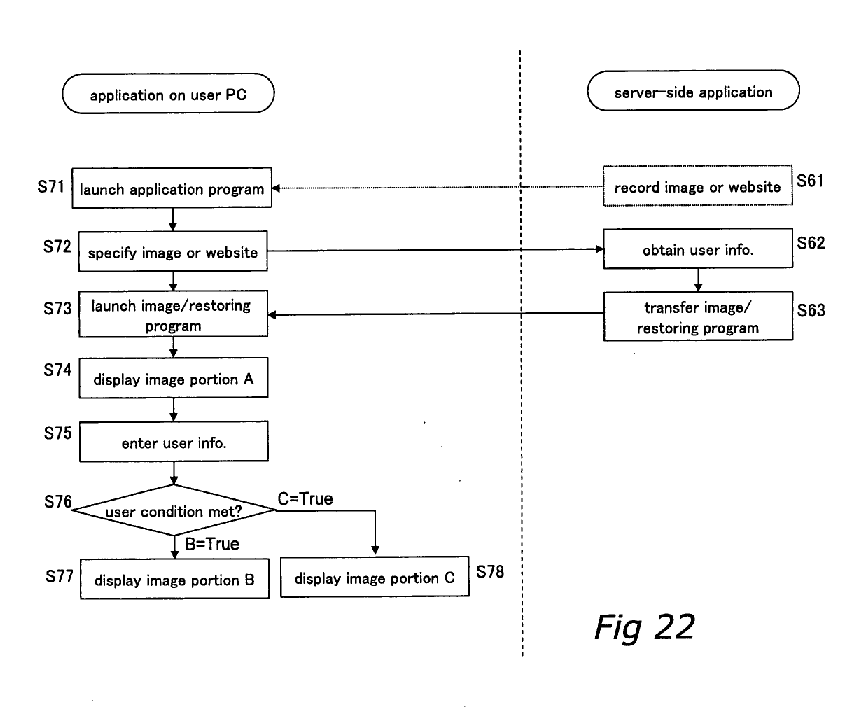

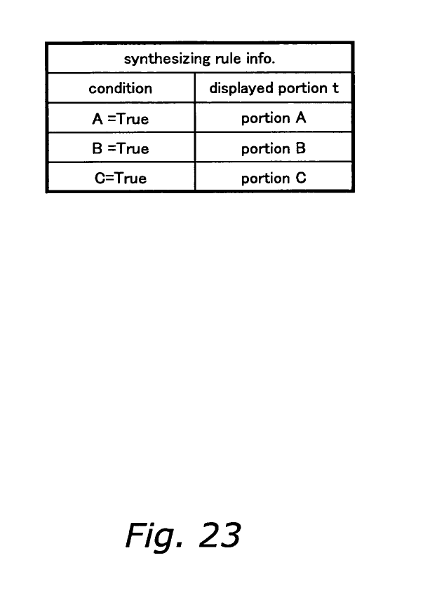

As the image display processing method, it is also possible to store the data of three or more images in one file format, and to display one of the image data in accordance with the evaluation of the user authentication result and the expiration date, for example. Such a process is explained as image display process 2 with reference to FIGS. 21 and 22.

A web server 600 is configured to manage a data storage portion 610, which manages HTML documents including image data to be distributed, and to distribute image data in response to requests from a client terminal 620.

The client terminal 620 manages a data storage portion 630, which can store the distributed data, and stores HTML documents including image data distributed from the web server 600 in the data storage portion 630.

An application stored in the distributed data is launched by the client terminal 620, the user environment information is judged, and a display image 640 is displayed with a display means, based on the result of that judgment.

The image data “a.jpg” distributed from the web server 600 is a file format structure including a first file 651, a second file 652 and a third file 653, and first image data 641 obtained by expanding the first file 651, second image data 642 obtained by expanding the second file 652 or third image data 643 obtained by expanding the third file 653 is displayed depending on an evaluation result.

The image synthesizing rule can be expressed by a table as shown in FIG. 23. In this case, the first file 651 is selected from the file “a.jpg” if the evaluation result for condition A is “true,” the second file 652 is selected if the evaluation result for condition B is “true,” and the third file 653 is selected if the evaluation result for condition C is “true.”

FIG. 22 is a flowchart showing the process flow according to this image display process 2.

At Step S61, the application on the side of the web server 600 records the URL of image data or a web page.

At Step S71, the client terminal 620 launches an application program such as a browser for connecting to the Internet and accessing the image data or the web page recorded by the server.

At Step S72, information specifying the image data or web page specified by the user is entered into the client terminal 620 and this specifying information and user information is sent to the web server 600.

At Step S62, the web server 600 obtains the specifying information and the user information sent from the client terminal 620.

At Step S63, the web server 600 prepares the image data specified by the specifying information from the client terminal 620, generates an image synthesizing rule based on the obtained user information, and sends this image synthesizing rule and the image-viewing application for restoring the image data together with the image data to the client terminal 620.

At Step S73, the client terminal 620 launches the image-viewing application distributed by the web server 600.

At Step S74, the image-viewing application launched by the client terminal 620 displays the image data specified as default with the image-viewing application. For example, if configured to select the first file 651 when no information is input by the user, then this first file 651 is expanded and the first image data 641 displayed.

At Step S75, the image-viewing application of the client terminal 620 receives the user environment information entered by the user. Here, both a user ID and a password, a fingerprint or voiceprint or other biometrical information, a client terminal ID, the current time, and a command input relating to display control or the like are received as user environment information.

At Step S76, the image-viewing application compares the user environment information entered by the user with the image generation information included in the distributed data. A user authentication is performed, for example, by comparing the user ID, the password, the user biometrical information and the client terminal ID or the like included in the user environment information entered by the user with the user environment information included in the image generation information. Moreover, based on the obtained current time information, it is determined whether the expiration date has passed or not. Furthermore, it is determined whether a command relating to display control, such as a copy (and paste), printscreen or capture command, has been entered. As a result, if the user environment information entered by the user matches the condition B, the procedure advances to Step S77, and if it matches the condition C, the procedure advances to Step S78.

At Step S77, in accordance with the matched condition B, the image-viewing application selects the second file 652, expands this second file 652, and displays the second image data 642.

At Step S78, in accordance with the matched condition C, the image-viewing application selects the third file 653, expands this third file 653, and displays the third image data 643.

Image Display Process 3

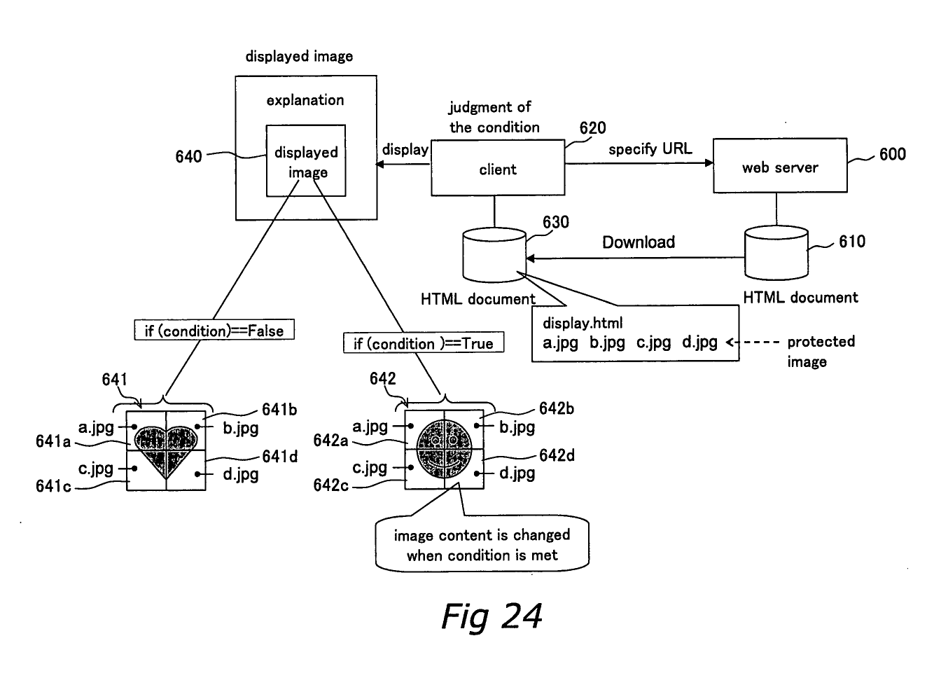

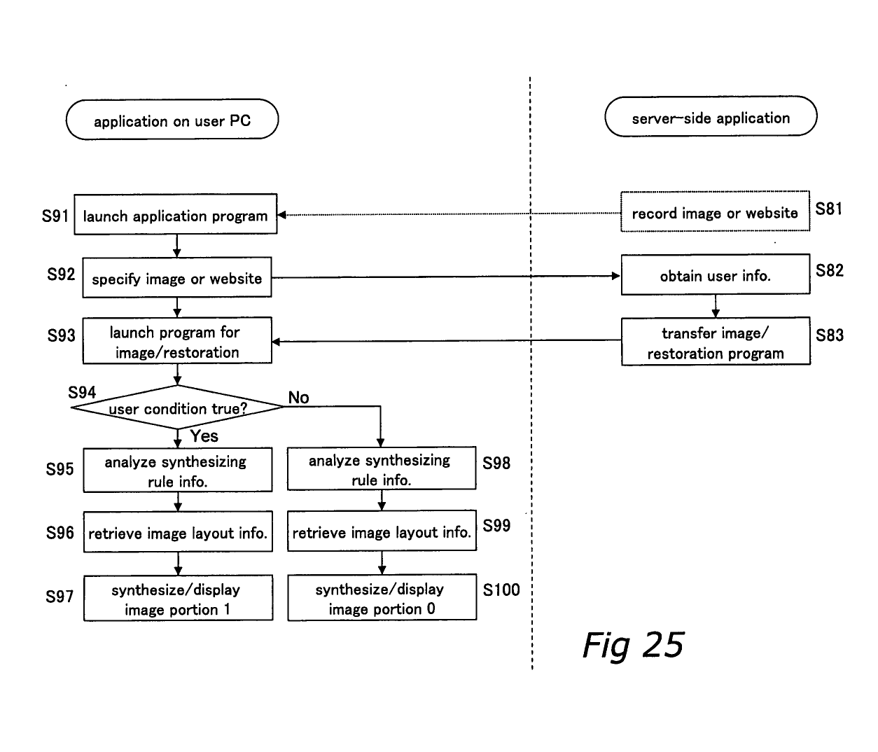

As the image display processing method, it is also possible to prepare image data for authorized users and image data for unauthorized users of the same display size, partition them into a plurality of data portions, and distribute each of the data portions in one file, depending on the corresponding display position. Such a process is explained as image display process 3 with reference to FIGS. 24 and 25.

A web server 600 is configured to manage a data storage portion 610, which manages HTML documents including image data to be distributed, and to distribute image data in response to requests from a client terminal 620.

The client terminal 620 manages a data storage portion 630, which can store the distributed data, and stores HTML documents including image data distributed from the web server 600 in the data storage portion 630.

An application stored in the distributed data is launched by the client terminal 620, the user environment information is judged, and a display image 640 is displayed with a display means, based on the result of that judgment.

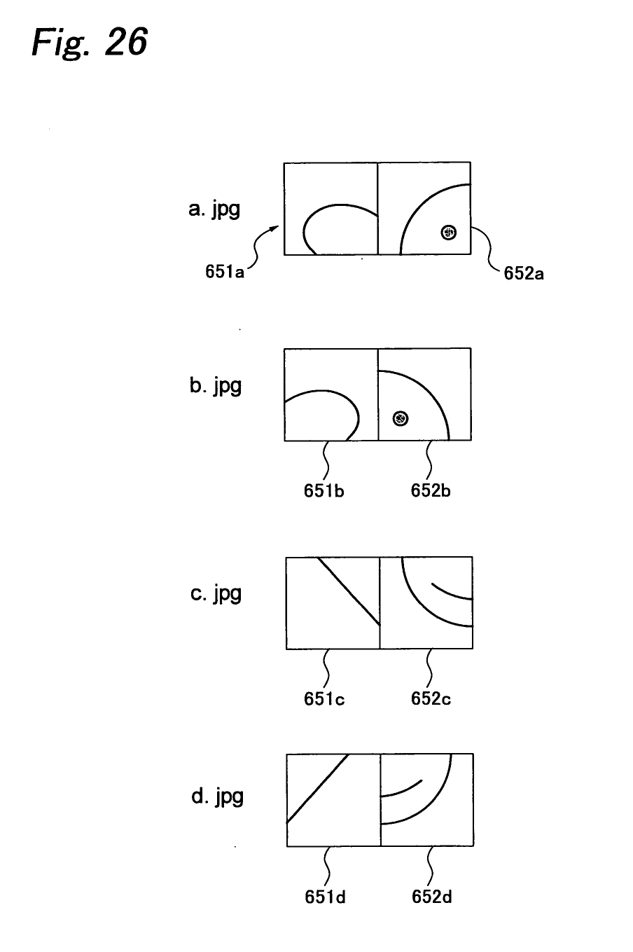

The image data distributed from the web server 600 includes image data 641 for unauthorized users, which is displayed to unauthorized users, and image data 642 for authorized users, which is displayed to unauthorized users, both having the same display size. The image data 641 for unauthorized users is partitioned into data portions 641a to 641d, and the image data 642 for authorized users is partitioned into data portions 642a to 642d. The data portions 641a to 641d of the image data 641 for unauthorized users and the data portions 642a to 642d of the image data 642 for authorized users are set such that their display sizes and display positions correspond to one another. As the distributed data, one file is synthesized for every data portion with the same display position, as shown in FIG. 26. For example, a first data portion 651a for generating first image data 641a and a second data portion 652a for generating second image data 642a of images located in the upper left constitute one data file “a.jpg,” and similarly, first data portions 651b to 651d for generating first image data 641b to 641d and second data portions 652b to 652d for generating second image data 642b to 642d with matching display positions are synthesized into single files, thus constituting “b jpg” to “d.jpg.”

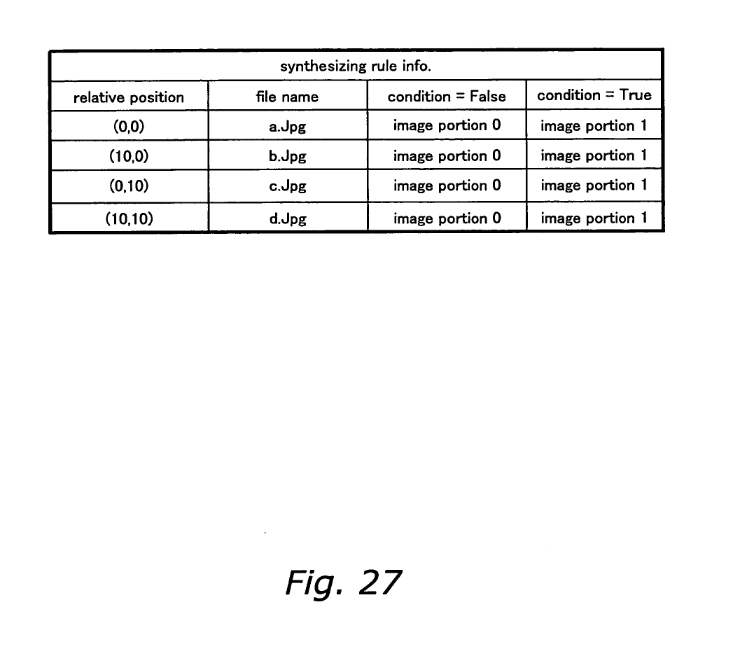

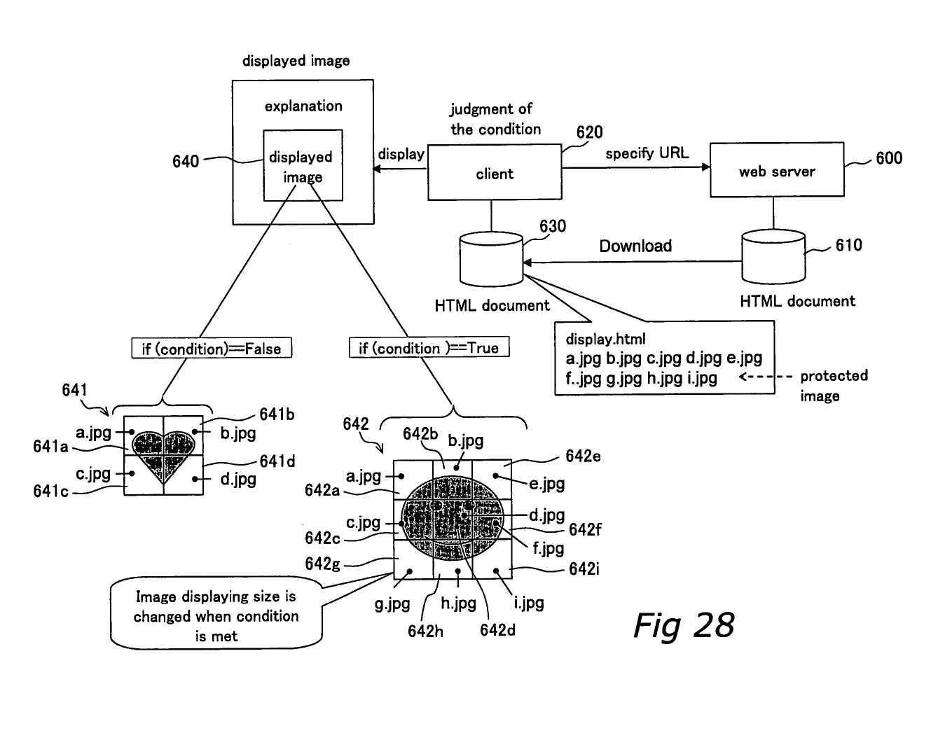

The image synthesizing rule of the thus distributed image data can be expressed as the table shown in FIG. 27. In accordance with this table, the files “ajpg” to “d.jpg” are respectively arranged at the relative display positions (0, 0), (10, 0), (0, 10) and (10, 10), if the condition is “false,” then the first data portions are selected, whereas if the condition is “true,” then the second data portions are selected.

FIG. 25 is a flowchart showing the process flow according to this image display process 3.

At Step S81, the application on the side of the web server 600 records the URL of image data or a web page.

At Step S91, the client terminal 620 launches an application program such as a browser for connecting to the Internet and accessing the image data or the web page recorded by the server.

At Step S92, information specifying the image data or web page specified by the user is entered into the client terminal 620 and this specifying information and user information is sent to the web server 600.

At Step S82, the web server 600 obtains the specifying information and the user information sent from the client terminal 620.

At Step S83, the web server 600 prepares the image data specified by the specifying information from the client terminal 620, generates an image synthesizing rule based on the obtained user information, and sends this image synthesizing rule and the image-viewing application for restoring the image data together with the image data to the client terminal 620.

At Step S93, the client terminal 620 launches the image-viewing application distributed by the web server 600.

At Step S94, the image-viewing application launched by the client terminal 620 receives the user environment information entered by the user, and compares the user environment information entered by the user with image generation information included in the distributed data. A user authentication is performed, for example, by comparing the user ID, the password, the user biometrical information and the client terminal ID or the like included in the user environment information entered by the user with the user environment information included in the image generation information. Moreover, based on the obtained current time information, it is determined whether the expiration date has passed or not. Furthermore, it is determined whether a command relating to display control, such as a copy (and paste), printscreen or capture command, has been entered. As a result, if the user environment information entered by the user matches the condition, the procedure advances to Step S95, and otherwise, the procedure advances to Step S98.

At Step S95, the image-viewing application analyzes the image generation information included in the distributed data, and extracts the image synthesizing rule. Here, information is obtained that indicates whether the second data portions 652a to 652d in the distributed files “a.jpg” to “d.jpg” are encrypted or not, the encryption method, whether other image data has been embedded as an electronic watermark, the embedding format, as well as other storage methods.

At Step S96, the image-viewing application obtains the image layout information based on the obtained image synthesizing rule. Here, relative positional information specifying at which positions the image data portions are displayed is obtained.

At Step S97, the image-viewing application selects the second data portions from the files “a.jpg” to “d.jpg” based on the image synthesizing rule, decrypts them if encrypted, or, if other image data is embedded as a watermark, extracts that other image data, arranges the image portions based on the positional information, and displays the image data 642 for authorized users.

At Step S98, the image-viewing application analyses the image generation information included in the distributed data, and extracts the image synthesizing rule. Here, a rule regarding the synthesizing of the first data portions 651a to 651d of the distributed files “a.jpg” to “d.jpg” is obtained from the image generation information.

At Step S99, the image-viewing application obtains the image layout information based on the obtained image synthesizing rule. Here, relative positional information specifying at which positions the image data portions are displayed is obtained.

At Step S100, the image-viewing application selects the first data portions of the files “a.jpg” to “d.jpg” based on the obtained image synthesizing rule, arranges them in accordance with the positional information, and displays the image data 641 for unauthorized users.

Image Display Process 4

If the display sizes of the image data for authorized users and the image data for unauthorized users are different, then it is conceivable to partition them each into a plurality of data portions before distributing them. Such a process is explained as image display process 4 with reference to FIGS. 24 and 25.

A web server 600 is configured to manage a data storage portion 610, which manages HTML documents including image data to be distributed, and to distribute image data in response to requests from a client terminal 620.

The client terminal 620 manages a data storage portion 630, which can store the distributed data, and stores HTML documents including image data distributed from the web server 600 in the data storage portion 630.

An application stored in the distributed data is launched by the client terminal 620, the user environment information is judged, and a display image 640 is displayed with a display means, based on the result of that judgment.

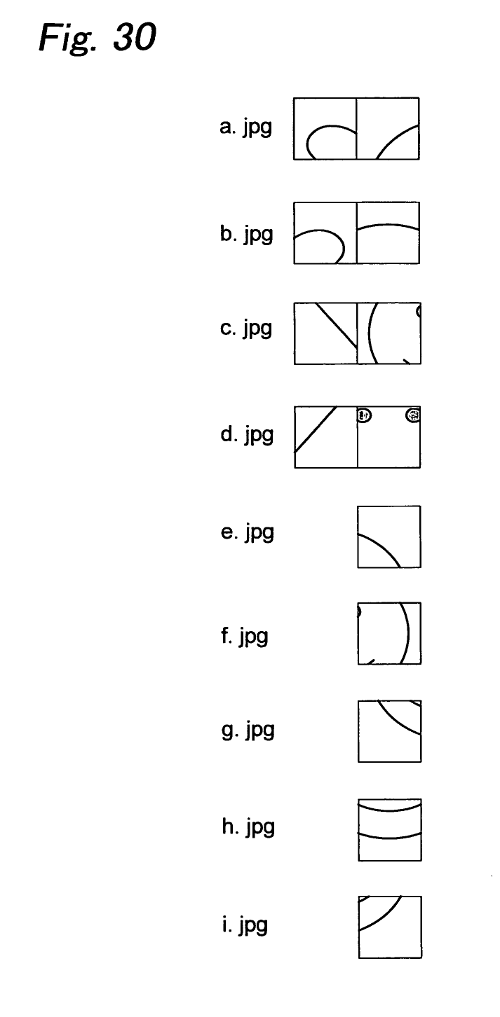

The image data distributed from the web server 600 includes image data 641 for unauthorized users, which is displayed to unauthorized users, and image data 642 for authorized users, which is displayed to unauthorized users. The image data 641 for unauthorized users is partitioned into data portions 641a to 641d, and the image data 642 for authorized users is partitioned into data portions 642a to 642i. Those of the data portions 641a to 641d of the image data 641 for unauthorized users and the data portions 642a to 642i of the image data 642 for authorized users that have a corresponding display size and display position constitute one file format structure, whereas for those data portions for which there is no data file with corresponding display size, one half of the file is left blank. For example, as shown in FIG. 30, the data portions with corresponding display positions together constitute single files, and the first data portions 651a to 651d for generating the first image data 641a to 641d together with the second data portions 652a to 652d for generating the second image data 642a to 642d constitute single data files “a.jpg” to “d.jpg.” Moreover, where there is no first image data at the corresponding positions, as for the second image data 642e to 642i, the data files “e.jpg” to “i.jpg” are constituted by just the second image data.

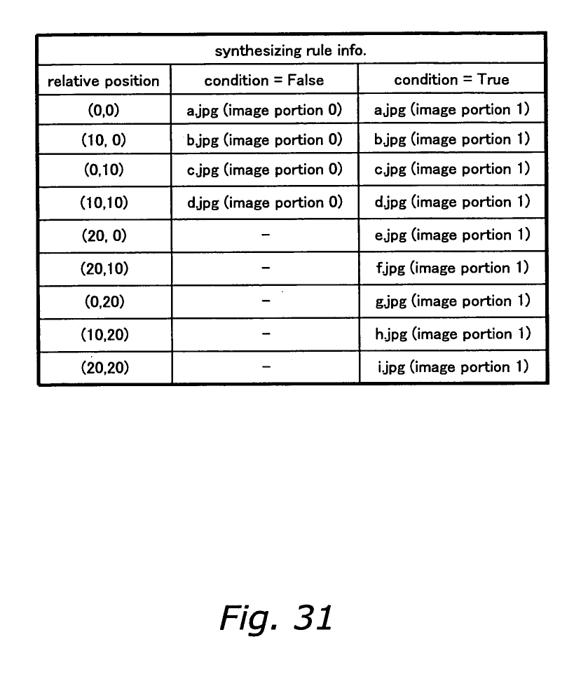

The image synthesizing rule of the thus distributed image data can be expressed as the table shown in FIG. 31. In accordance with this table, the files “a.jpg” to “i.jpg” are respectively arranged at the relative display positions (0, 0), (10, 0), (0, 10), (10, 10), (20, 0), (20, 10), (0, 20), (10, 20) and (20, 20), and if the condition is “false,” then the first data portions are selected, whereas if the condition is “true,” then the second data portions are selected.

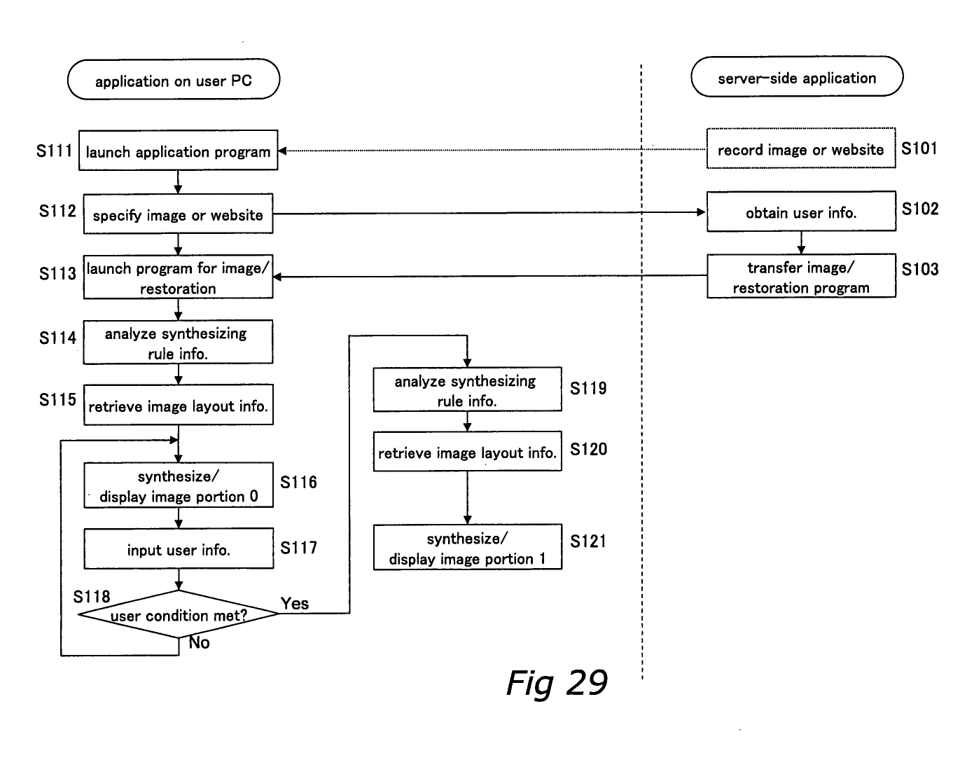

FIG. 29 is a flowchart showing the process flow according to this image display process 4.

At Step S101, the application on the side of the web server 600 records the URL of image data or a web page.

At Step S111, the client terminal 620 launches an application program such as a browser for connecting to the Internet and accessing the image data or the web page recorded by the server.

At Step S112, information specifying the image data or web page specified by the user is entered into the client terminal 620 and this specifying information and user information is sent to the web server 600.

At Step S102, the web server 600 obtains the specifying information and the user information sent from the client terminal 620.

At Step S103, the web server 600 prepares the image data specified by the specifying information from the client terminal 620, generates an image synthesizing rule based on the obtained user information, and sends this image synthesizing rule and the image-viewing application for restoring the image data together with the image data to the client terminal 620.

At Step S113, the client terminal 620 launches the image-viewing application distributed by the web server 600.

At Step S114, the image-viewing application of the client terminal 620 analyzes the image synthesizing rule from the image generation information stored in the distributed data.

At Step S115, the image-viewing application of the client terminal 620 obtains the image layout information of the image data portions 641a to 641d constituting the image data 641 for unauthorized users, which is displayed by default, from the files included in the distributed data.

At Step S116, in accordance with the obtained image layout information, the image-viewing application of the client terminal 620 selects and expands the first files 651a to 651d, and synthesizes and displays the image data 641 for unauthorized users.

At Step S117, the image-viewing application of the client terminal 620 receives the user environment information entered by the user.

At Step S118, the image-viewing application of the client terminal 620 compares the user environment information entered by the user with image generation information included in the distributed data. A user authentication is performed, for example, by comparing the user ID, the password, the user biometrical information and the client terminal ID or the like included in the user environment information entered by the user with the user environment information included in the image generation information. Moreover, based on the obtained current time information, it is determined whether the expiration date has passed or not. Furthermore, it is determined whether a command relating to display control, such as a copy (and paste), printscreen or capture command, has been entered. As a result, if the user environment information entered by the user matches the condition, the procedure advances to Step S119, and otherwise, the procedure advances to Step S116.

At Step S119, the image-viewing application analyzes the image generation information included in the distributed data, and extracts the image synthesizing rule. Here, information is obtained that indicates whether the second data portions 652a to 652i in the distributed files “a.jpg” to “d.jpg” are encrypted or not, the encryption method, whether other image data has been embedded as an electronic watermark, the embedding format, as well as other storage methods.

At Step S120, the image-viewing application obtains the image layout information based on the obtained image synthesizing rule. Here, relative positional information specifying at which positions the image data portions 642a to 642i constituting the image data 642 for authorized users are displayed is obtained.

At Step S121, the image-viewing application selects the second data portions from the files “a.jpg” to “i.jpg” based on the obtained image synthesizing rule, decrypts them if encrypted, or, if other image data is embedded as a watermark, extracts that other image data, arranges the image portions based on the positional information, and displays the image data 642 for authorized users.

Image Display Process 5

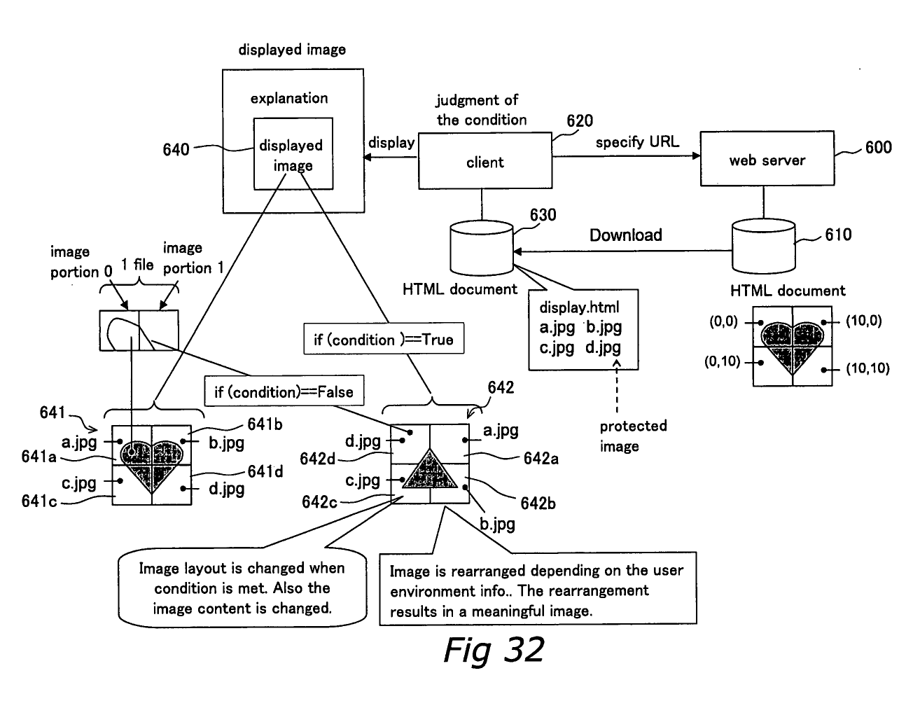

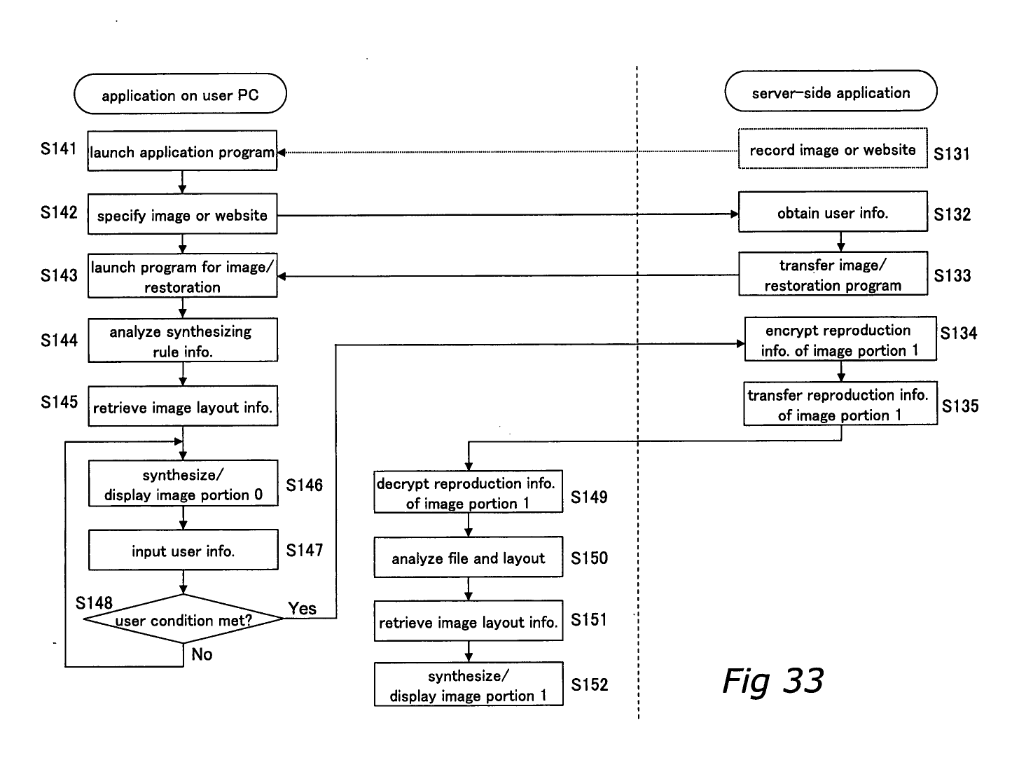

In another possible configuration, the image data for authorized users and the image data for unauthorized users are each partitioned into a plurality of data portions, and data portions with different layout information are stored in a single file format structure. Such a process is explained as image display process 5 with reference to FIGS. 32 and 33.

A web server 600 is configured to manage a data storage portion 610, which manages HTML documents including image data to be distributed, and to distribute image data in response to requests from a client terminal 620.

The client terminal 620 manages a data storage portion 630, which can store the distributed data, and stores HTML documents including image data distributed from the web server 600 in the data storage portion 630.

An application stored in the distributed data is launched by the client terminal 620, the user environment information is judged, and a display image 640 is displayed with a display means, based on the result of that judgment.

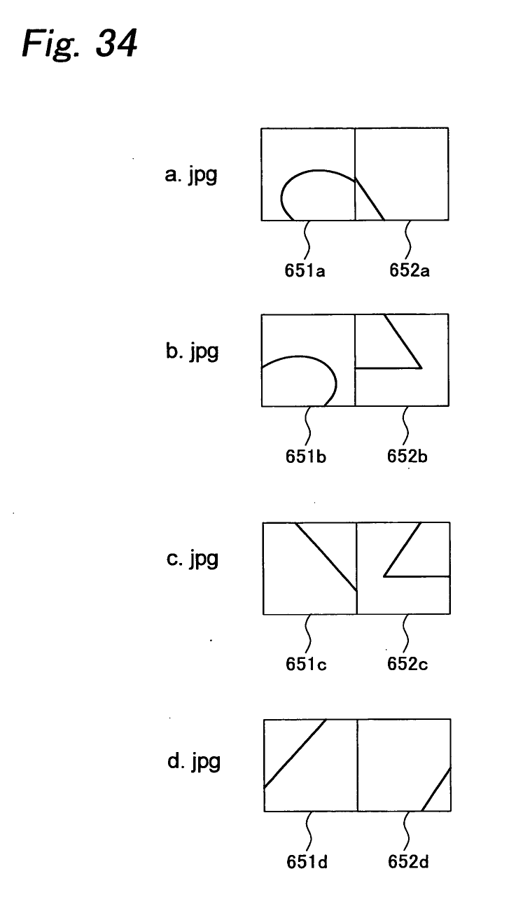

The image data distributed from the web server 600 includes image data 641 for unauthorized users, which is displayed to unauthorized users, and image data 642 for authorized users, which is displayed to unauthorized users. The image data 641 for unauthorized users is partitioned into data portions 641a to 641d, and the image data 642 for authorized users is partitioned into data portions 642a to 642d. Here, data portions 641a to 641d of the image data 641 for unauthorized users and data portions 642a to 642d of the image data 642 for authorized users that have different display positions, even though they have the same display size, together constitute a single file. For example, as shown in FIG. 34, the data file “a.jpg” is constituted by a first file 651a corresponding to first image data 641a constituting the upper left portion of the image data 641 for unauthorized users, and a second file 652b corresponding to second image data 642a constituting the upper right portion of the image data 642 for authorized users. Similarly, the data files “b.jpg” to “d.jpg” are constituted by the first files 651b to 651d and the second files 652b to 652d, but the first files and the second files respectively have different display positions.

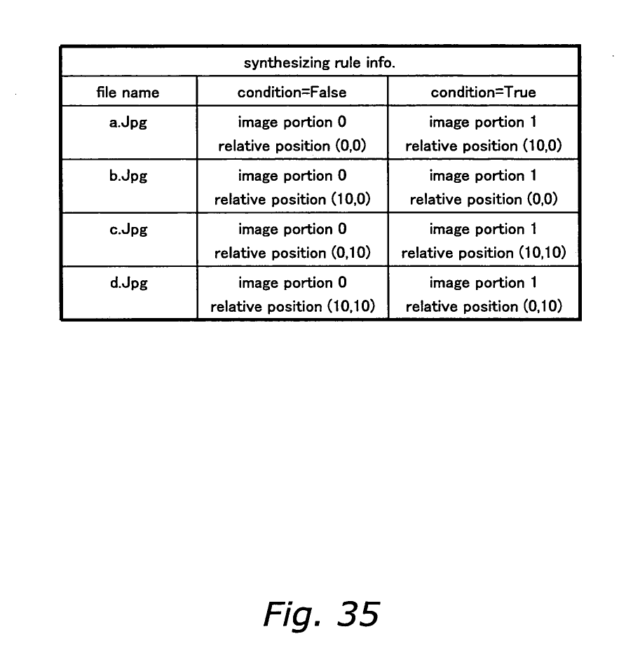

The image synthesizing rule of the image data distributed in this manner can be expressed by the table shown in FIG. 35. In accordance with this table, the selected file name and its relative positional information for the data files “a.jpg” to “d.jpg” are set depending on whether the condition is “false” or “true,”

FIG. 33 is a flowchart showing the process flow according to this image display process 5.

At Step S131, the application on the side of the web server 600 records the URL of image data or a web page.

At Step S141, the client terminal 620 launches an application program such as a browser for connecting to the Internet and accessing the image data or the web page recorded by the server.

At Step S142, information specifying the image data or web page specified by the user is entered into the client terminal 620 and this specifying information and user information is sent to the web server 600.

At Step S132, the web server 600 obtains the specifying information and the user information sent from the client terminal 620.

At Step S133, the web server 600 prepares the image data specified by the specifying information from the client terminal 620, and sends the obtained user information and the image-viewing application for restoring the image data together with the image data to the client terminal 620.

At Step S143, the client terminal 620 launches the image-viewing application distributed by the web server 600.

At Step S144, the image-viewing application of the client terminal 620 analyzes the image synthesizing rule from the image generation information stored in the distributed data.

At Step S145, the image-viewing application of the client terminal 620 obtains the image layout information of the image data portions 641a to 641d constituting the image data 641 for unauthorized users, which is displayed by default, from the files included in the distributed data.

At Step S146, in accordance with the obtained image layout information, the image-viewing application of the client terminal 620 selects and expands the first files 651a to 651d, and synthesizes and displays the image data 641 for unauthorized users.

At Step S147, the image-viewing application of the client terminal 620 receives the user environment information entered by the user.

At Step S148, the image-viewing application of the client terminal 620 compares the user environment information entered by the user with image generation information included in the distributed data. A user authentication is performed, for example, by comparing the user ID, the password, the user biometrical information and the client terminal ID or the like included in the user environment information entered by the user with the user environment information included in the image generation information. Moreover, based on the obtained current time information, it is determined whether the expiration date has passed or not. Furthermore, it is determined whether a command relating to display control, such as a copy (and paste), printscreen or capture command, has been entered. As a result, if the user environment information entered by the user matches the condition, the procedure advances to Step S134, and otherwise, the procedure advances to Step S146.

At Step S134, the web server 600 generates second image portion reproduction information for reproducing the image data 642 for authorized users from the data distributed to the client terminal 620, and encrypts this second image portion reproduction information. The second image reproduction information includes relative positional information for the second files 652a to 652d included in the data files “a.jpg” to “d.jpg,” and the encryption key with which the second image generation information is encrypted may be embedded in form of an invisible watermark.

At Step S135, the web server 600 sends the second image reproduction information to the client terminal 620.

At Step S149, the image-viewing application of the client terminal 620 decrypts the second image reproduction information that has been sent from the web server 600. If the encryption key for the decryption is embedded in form of an invisible watermark in the second image reproduction information that has been sent, then it may be extracted, or if it is embedded in form of an invisible watermark in the data file that had been distributed at first, then it is extracted from that data file and decryption is performed.

At Step S150, the image-viewing application of the client terminal 620 analyzes the correspondence between the data file included in the decrypted second image reproduction information and the relative positional information.

At Step S151, the client terminal 620 extracts the relative positional information corresponding to the image data portions of the second image data.

At Step S152, the image-viewing application selects the second data portions from the files “a.jpg” to “d.jpg,” arranges them in accordance with the relative positional information, and displays the image data 642 for authorized users.

Image Display Process 6

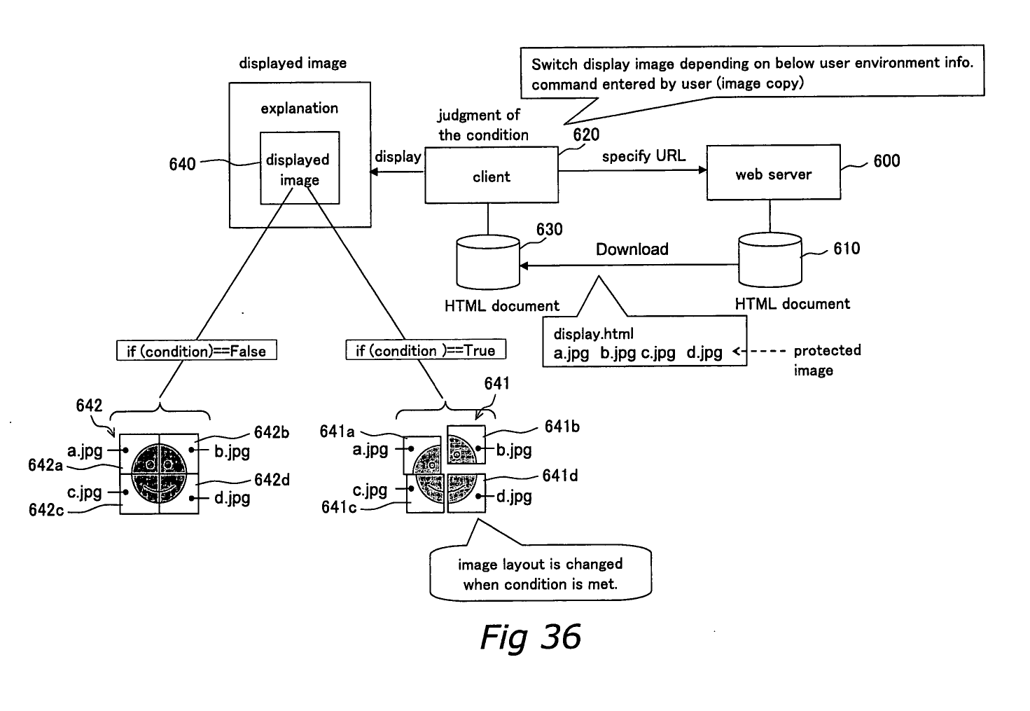

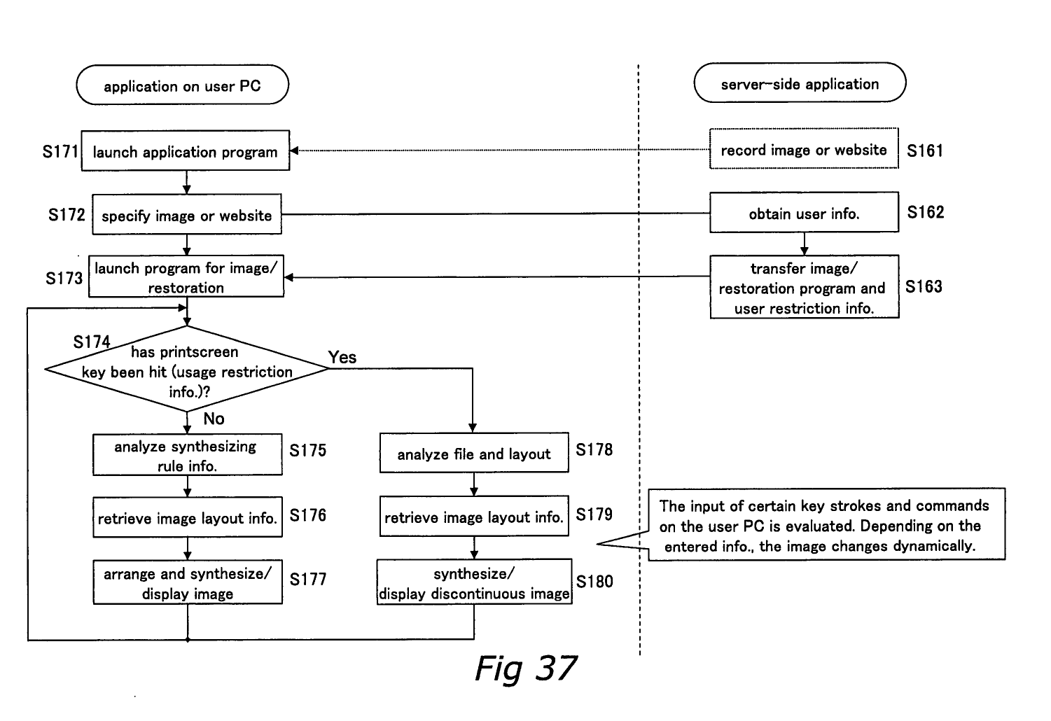

In another possible configuration, the image data for authorized users and the image data for unauthorized users are substituted with a single set of image data by switching the method for displaying the image data. Such a process is explained as image display process 6 with reference to FIGS. 36 and 37.

A web server 600 is configured to manage a data storage portion 610, which manages HTML documents including image data to be distributed, and to distribute image data in response to requests from a client terminal 620.

The client terminal 620 manages a data storage portion 630, which can store the distributed data, and stores HTML documents including image data distributed from the web server 600 in the data storage portion 630.

An application stored in the distributed data is launched by the client terminal 620, the user environment information is judged, and a display image 640 is displayed with a display means, based on the result of that judgment.

The image data distributed from the web server 600 is partitioned into “a.jpg” to “d.jpg” before being distributed, and is configured such that for image data 642 for authorized users, which is displayed to authorized users having proper usage rights, the image data portions 642a to 642d are arranged at the proper positions, and the original image data is displayed. On the other hand, the image data 641 for unauthorized users, which is displayed to unauthorized users, has relative positional information with which the image data portions 641a to 641d of “a.jpg” to “d.jpg” are not properly displayed, but instead are each displayed at a shifted position.

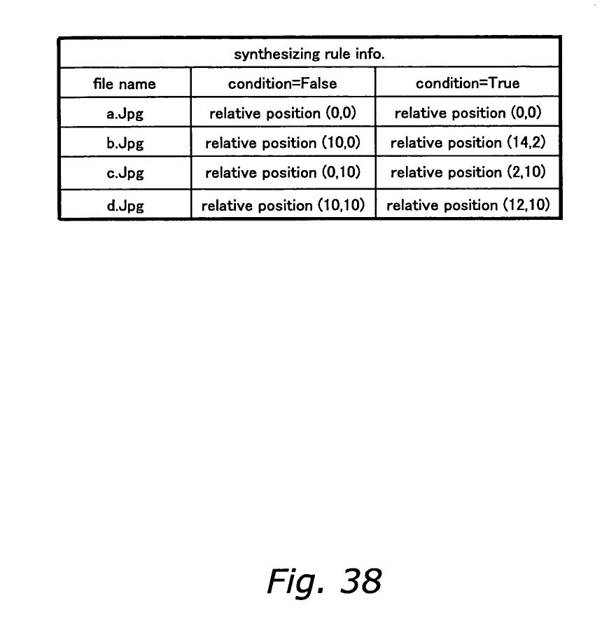

The image synthesizing rule of the image data distributed in this manner can be expressed by the table shown in FIG. 38. In accordance with this table, the relative positional information for the data files “a.jpg” to “d.jpg” is set depending on whether the condition is “false” or “true,”

FIG. 37 is a flowchart showing the process flow according to this image display process 6.

At Step S161, the application on the side of the web server 600 records the URL of image data or a web page.

At Step S171, the client terminal 620 launches an application program such as a browser for connecting to the Internet and accessing the image data or the web page recorded by the server.

At Step S172, information specifying the image data or web page specified by the user is entered into the client terminal 620 and this specifying information and user information is sent to the web server 600.

At Step S162, the web server 600 obtains the specifying information and the user information sent from the client terminal 620.

At Step S163, the web server 600 prepares the image data specified by the specifying information from the client terminal 620, generates user restriction information based on the obtained user information, and sends it together with the image data and the image-viewing application for restoring the image data to the client terminal 620.

At Step S173, the client terminal 620 launches the image-viewing application distributed by the web server 600.

At Step S174, the image-viewing application of the client terminal 620 determines whether there is a match for user restriction information included in the distributed data. This user restriction information may be configured such that if a command relating to display control, such as a copy (and paste), printscreen or capture command, has been entered, then the image data 641 for unauthorized users is displayed with the image data portions 641a to 641d arranged at discontinuous positions. If it is determined that a command relating to such display control has been entered, then the procedure advances to Step S178, and otherwise the procedure advances to Step S175.

At Step S175, the image-viewing application of the client terminal 620 analyzes the image synthesizing rule from the image generation information stored in the distributed data.

At Step S176, the image-viewing application of the client terminal 620 obtains the image layout information of the image data portions 641a to 641d for reproducing the proper image data, from the files included in the distributed data.

At Step S177, in accordance with the obtained image layout information, the image-viewing application of the client terminal 620 expands the image data portions, and synthesizes and displays the image data 642 for authorized users.

At Step S178, the image-viewing application of the client terminal 620 analyzes the files of the image data portions and their layout information, in order to display the image data 641 for unauthorized users, from the image generation information included in the distributed data.

At Step S179, the image-viewing application of the client terminal 620 obtains the relative positional information of the image data portions for displaying the image data 641 for unauthorized users.

At Step S180, the image-viewing application of the client terminal 620 arranges the image data portions 641a to 641d in accordance with the relative positional information, and displays the discontinuous image data 641 for unauthorized users.

Process for Generating Protected Images

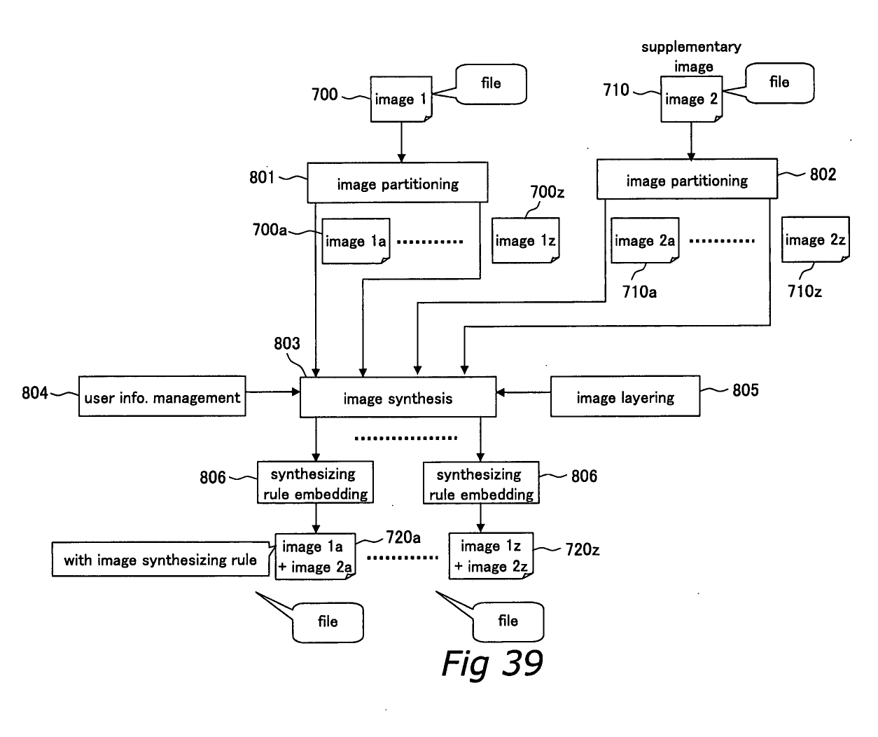

A process for generating image data to be distributed is explained with reference to FIG. 39.

Here, a case is considered in which first image data 700 and second image data 710 are partitioned into a plurality of image data portions, and the image data portions are distributed after combining them into file format structures.

The first image data 700 is partitioned by an image partitioning portion 801 into a plurality of image data portions 700a to 700z with predetermined display sizes.

Similarly, the second image data 710 are partitioned by an image partitioning portion 802 into a plurality of image data portions 710a to 710z with predetermined display sizes.

The first image data 700 and the second image data 710 may be partitioned into the same number of image data portions of the same display size, or they may be partitioned into a different number of image data portions of different display sizes.

The partitioned image data portions 700a to 700z and 710a to 710z are synthesized by an image synthesizing portion 803. Here, the user environment information managed by a user information managing portion 804 is layered in form of an invisible watermark or a file format structure, based on a layering process managed by an image layering portion 805.

Moreover, an image synthesizing rule for reproducing the layered image data is embedded in the layered data by a synthesizing rule embedding portion 806. This image synthesizing rule may be stored together with the user environment information in form of an invisible watermark or in a redundant portion of the file format structure. Thus, each of the image data portions is formed by data files 720a to 720z combining a first data portion and a second data portion.

Switching the Display Depending on the Usage Condition

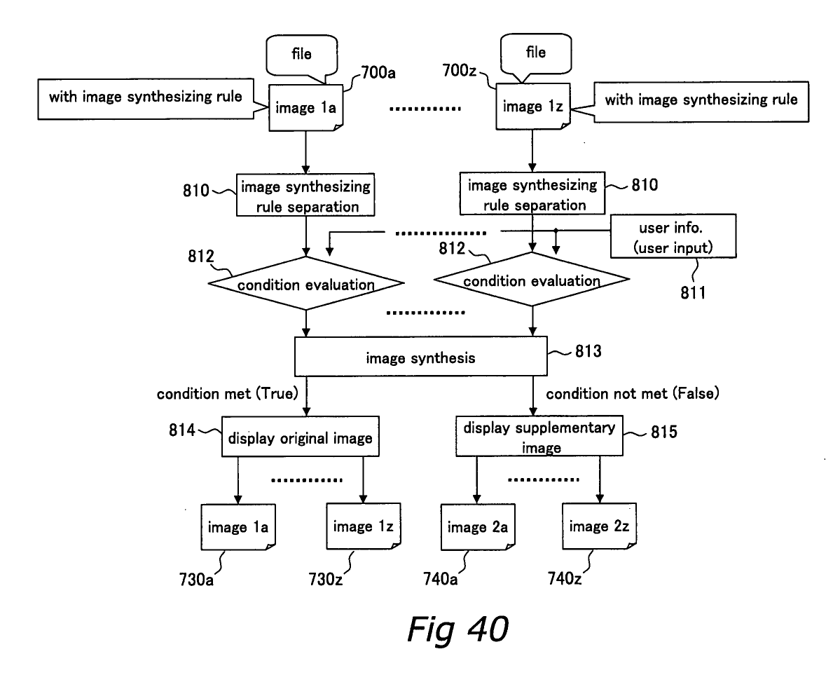

Referring to FIG. 40, the following is an explanation of the case that the image display is switched in accordance with the user information.

A synthesizing rule separation portion 810 performs an image synthesizing rule separation process on the image files 700a to 700z in which the information related to the image synthesizing rule has been set in advance.

A user information obtaining portion 811 obtains the user information entered by the user, and a condition evaluation portion 812 evaluates the condition of the image synthesizing rule based on the image synthesizing rule separated from the image files and the obtained user information.

If the condition generated by the image synthesizing portion 813 based on the evaluation result of the condition evaluation portion 812 is met, then the displayed image files 730a to 739z are generated, and if the condition is not met, then the displayed image files 740a to 740z are generated, synthesized together with the evaluation result, and distributed.

Based on the user environment information entered by the user, of the data downloaded to the client terminal, the image data for authorized users (original image) 814 is displayed if the condition is met, and the image data for unauthorized users (supplementary image) 815 is displayed if the condition is not met.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A data handling method comprising:
a step of associating display content of data to be distributed with user environment information including user license information, user authentication result information and user operation information, and generating data generation information related to a method for reproducing data based on the display content;
a step of processing the data to be distributed based on the data generation information, storing the data generation information in the data to be distributed, and layering and distributing the data;
a step of obtaining the user environment information of a user attempting to utilize the data, and looking up the data generation information included in the distributed data to select a data reproduction method that corresponds to the user environment information; and
a step of reproducing the distributed data based on the selected data reproduction method.

2. The data handling method according to claim 1, wherein the data to be distributed includes at least two sets of data based on the data reproduction method, and the corresponding set of data is reproduced with the data reproduction method selected in accordance with the obtained user environment information.

3. The data handling method according to claim 1, wherein the data to be distributed is partitioned into a plurality of data portions, and some or all of the data portions are synthesized and reproduced by the data reproduction method selected in accordance with the obtained user environment information.

4. The data handling method according to claim 3, wherein at least two sets of data are partitioned into a plurality of data portions, and the data portions are layered and distributed.

5. The data handling method according to any of claims 1 to 4, wherein operation information of an information processing device of the user is monitored by an application that is activated when the distributed data has been downloaded onto the information processing device, and the data reproduction method is selected based on the operation information obtained by the application.

6. The data handling method according to any of claims 1 to 4, wherein an authentication is performed based on user authentication information entered into an information processing device of the user, and the data reproduction method is selected based on the result of this authentication.

7. The data handling method according to any of claims 1-4, wherein the distributed data is data of a plurality of images, and stored in a watermark or a redundant area of a file format structure.

8. The data handling method according to claim 7, wherein the data of at least one of the plurality images is encrypted by an encryption key, and the encryption key is stored in the distributed data as a portion of the data generation information.

9. An apparatus for generation of distribution data comprising:
a rule generating means for associating display content of data to be distributed with user environment information including user license information, user authentication result information, user operation information, and generating data generation information related to a method for reproducing data based on the display content; and
a data generating means for processing the data to be distributed based on the data generation information, storing the data generation information in the data to be distributed, and layering the data.

10. The apparatus for generation of distribution data according to claim 9, further comprising a user environment information managing means for managing user environment information of users to which data is distributed.

11. The apparatus for generation of distribution data according to claim 9 or 10, wherein the data generating means includes a data partitioning means for partitioning the data to be distributed into a plurality of data portions, and a data layering means for layering the partial data that has been partitioned by the data partitioning means.

12. An apparatus for reproduction of distribution data comprising:
a user environment information obtaining means for obtaining user environment information of a user attempting to utilize data;
a rule analyzing means for looking up data generation information included in the distributed data to select a data reproduction method corresponding to the user environment information; and
a data reproducing means for reproducing the distributed data with the data reproduction method selected by the rule analyzing means.

13. The apparatus for reproduction of distribution data according to claim 12, wherein the data reproduction means includes a data synthesizing means for synthesizing and reproducing the data portions included in the distributed data, based on the data reproduction method selected by the rule analyzing means.

14. A data handling system comprising:
a rule generating means for associating display content of data to be distributed with user environment information including user license information, user authentication result information and user operation information, and generating data generation information related to a method for reproducing data based on the display content;
a data generating means for processing the data to be distributed based on the data generation information, storing the data generation information in the data to be distributed, and layering the data;
a user environment information obtaining means for obtaining user environment information of a user attempting to utilize data;
a rule analyzing means for looking up data generation information included in the distributed data to select a data reproduction method corresponding to the user environment information; and
a data reproducing means for reproducing the distributed data with the data reproduction method selected by the rule analyzing means.

15. A program letting a computer function as an apparatus for generation of distribution data, comprising:
a rule generating means for associating display content of data to be distributed with user environment information including user license information, user authentication result information and user operation information, and generating data generation information related to a method for reproducing data based on the display content; and
a data generating means for processing the data to be distributed based on the data generation information, storing the data generation information in the data to be distributed, and layering the data.

16. A program letting a computer function as an apparatus for reproduction of distribution data, comprising:
a user environment information obtaining means for obtaining user environment information of a user attempting to utilize data;
a rule analyzing means for looking up data generation information included in the distributed data to select a data reproduction method corresponding to the user environment information; and
a data reproducing means for reproducing the distributed data with the data reproduction method selected by the rule analyzing means.

17. A program letting a computer function as a data handling system comprising:
a rule generating means for associating display content of data to be distributed with user environment information including user license information, user authentication result information and user operation information, and generating data generation information related to a method for reproducing data based on the display content;
a data generating means for processing the data to be distributed based on the data generation information, storing the data generation information in the data to be distributed, and layering the data;
a user environment information obtaining means for obtaining user environment information of a user attempting to utilize data;
a rule analyzing means for looking up data generation information included in the distributed data to select a data reproduction method corresponding to the user environment information; and
a data reproducing means for reproducing the distributed data with the data reproduction method selected by the rule analyzing means.
